(19) United States
(12) Patent Application Publication
(10) Pub. No.: US 2026/0262560 A1
(43) Pub. Date: Sep. 10, 2026

(54) Seed Discs For Use With Seed Meters And Planters

(71) Applicant: MONSANTO TECHNOLOGY LLC, Saint Louis, MO (US)

(72) Inventors: Kenton HILKE, Saint Peters, MO (US); Kristopher KESSINGER, Brighton, IL (US); Elmer Xavier OBERE, Haiku, HI (US); Andrew David THIELEN, Scranton, IA (US); Timothy David TRUDEL, Kihei, HI (US); Charles WOLFERSBERGER, Saint Louis, MO (US)

(21) Appl. No.: 19/164,892

(22) PCT Filed: Mar. 15, 2024
(86) PCT No.: PCT/US2024/020162

§ 371 Date: Sep. 12, 2025

Related U.S. Application Data
(60) Provisional application No. 63/453,062, filed on Mar. 17, 2023.

(51) Int. Cl. A01C 7/04

(52) U.S. Cl. CPC A01C 7/046; A01C 7/0443; A01C 7/0445

(57) ABSTRACT

Seed discs, seed meters including the seed discs, and planters including the seed meters and the seed discs are provided. One example seed disc includes a plate and multiple seed receptacles configured to receive and hold seeds therein. The plate is defined by an outer perimeter and the seed receptacles are formed in the plate and spaced apart adjacent to, and within, the annular outer perimeter. At least one seed receptacle of the multiple seed receptacles includes an outer edge defining an aperture and one or more supports positioned within the aperture.

### CROSS-REFERENCE TO RELATED APPLICATION

This application claims the benefit of, and priority to, U.S. Provisional Application No. 63/453,062 filed on Mar. 17, 2023. The entire disclosure of the above application is incorporated herein by reference.

### FIELD

The present disclosure generally relates to seed discs (or seed plates) for use with seed meters and planters, and to seed meters and planters including such seed discs.

### BACKGROUND

This section provides background information related to the present disclosure which is not necessarily prior art.

Plant researchers often cultivate thousands of small plots of numerous different types and/or sizes of seeds in order to test/analyze different genotypic and/or phenotypic traits of the seeds and/or selected treatments applied thereto. In so doing, fields can comprise multiple such plots, and each of the plots may be planted with different types and/or different sizes of the seeds (in multiple different passes through the fields by planters). As an example, a plant researcher may plant, using a planter, a first plot in a given field with a first type of seeds in order to test/analyze the seeds. The plant researcher may then change the seed type at the planter to a second type of seeds and proceed in the field to plant the second type of seeds in order to test/analyze the second type of seeds.

### SUMMARY

This section provides a general summary of the disclosure and is not a comprehensive disclosure of its full scope or all of its features.

Example embodiments of the present disclosure generally relate to seed discs, for use with seed meters, for planting seeds of different sizes. In some example embodiments, such a seed disc generally includes a plate and multiple seed receptacles configured to receive, hold, entrain, etc. seeds on the plate. In various embodiments, the plate is defined by an outer perimeter and the seed receptacles are formed in the plate and spaced apart within the outer perimeter. In connection therewith, in various embodiments, at least one seed receptacle of the multiple seed receptacles includes an outer edge defining an aperture and one or more supports positioned within the aperture.

In other example embodiments, a seed meter for a planter configured to plant seeds in a field generally includes a seed disc and a rotatable drum operatively coupled to the seed disc. In various embodiments, the seed disc includes multiple seed receptacles each having an outer edge defining an aperture and one or more supports within the aperture, and the drum includes at least one seed pocket configured to hold seeds. The at least one seed pocket includes an opening configured to present the seeds to the seed disc. In connection therewith, in various embodiments, the seed disc is configured to rotate and the multiple receptacles are configured to receive, hold, entrain, etc. individual ones of the seeds in the apertures of the receptacles as the seeds are presented to the seed disc when the seed disc rotates.

In yet other example embodiments, a planter for planting seeds in a field includes at least one planting unit. In various embodiments, the at least one planting unit generally includes a seed meter having a seed disc and a rotatable drum operatively coupled to the seed disc. The seed disc includes multiple seed receptacles each having an outer edge defining an aperture and one or more supports within the aperture, and the drum includes at least one seed pocket configured to hold seeds. The at least one seed pocket includes an opening configured to present the seeds to the seed disc. In connection therewith, in various embodiments, the seed disc is configured to rotate and the multiple receptacles are configured to receive, hold, entrain, etc. individual ones of the seeds in the apertures of the receptacles as the seeds are presented to the seed disc when the seed disc rotates.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments, are not all possible implementations, and are not intended to limit the scope of the present disclosure.

FIG. 1 is a front view of an example embodiment of a seed disc of the present disclosure, for use with a seed meter to plant seeds in a field, where the seed disc includes seed receptacles with braces (or supports) for supporting, holding, maintaining, entraining, etc. seeds on the seed disc;

FIG. 2 is a perspective view of the seed disc of FIG. 1;

FIG. 3 is a rear view of the seed disc of FIG. 1;

FIG. 4 is an enlarged view of one of the seed receptacles defined in the seed disc of FIG. 1;

FIG. 5 is a front view of another example embodiment of a seed disc of the present disclosure, for use with a seed meter to plant seeds in a field, where the seed disc includes seed receptacles with braces (or supports) for supporting, holding, maintaining, entraining, etc. seeds on the seed disc;

FIG. 6 is an enlarged view of one of the seed receptacles defined in the seed disc of FIG. 5;

FIG. 7 is a rear view of the seed disc of FIG. 5;

FIG. 8 is a perspective view of an example embodiment of a seed meter of the present disclosure, in which the seed disc of FIG. 1 or the seed disc of FIG. 5 may be used and/or included;

FIG. 9 is another perspective view of the seed meter of FIG. 8, with a portion of a housing of the seed meter removed to illustrate internal components;

FIG. 10 is a perspective view of a drum of the seed meter of FIG. 8 for use in transporting seeds within the seed meter between different chambers;

FIG. 11 is a perspective view of the seed meter of FIG. 8, with another portion of the housing of the seed meter removed to illustrate the seed disc of the seed meter;

FIG. 12 is another additional perspective view of the seed meter of FIG. 8, with portions of the housing of the seed meter removed to illustrate chambers of the seed meter;

FIG. 13 is a perspective view of an example embodiment an ejector of the present disclosure, which may be used with the seed disc of FIG. 1, the seed disc of FIG. 5, and/or the seed meter of FIG. 8 for use in cleaning seed receptacles of the seed disc;

FIG. 14 is a side view of the ejector of FIG. 13;

FIG. 15 is an enlarged perspective view of the ejector of FIG. 13 aligned with the seed disc of FIG. 1, as may be included in the seed meter of FIG. 8;

FIG. 16A is a perspective view of a seed meter of the present disclosure, in which the seed meter includes a seed disc and an ejector;

FIG. 16B is another perspective view of the seed meter of FIG. 16A, with the seed disc removed;

FIG. 17 is a perspective view of another example embodiment of a seed meter of the present disclosure, in which the seed disc of FIG. 1 or FIG. 5 may be included, where the seed meter includes a planting tube for use in planting seeds;

FIG. 18 is another perspective view of the seed meter of FIG. 17;

FIG. 19 is a perspective view of the planting tube of the seed meter of FIG. 17, with a portion of the planting tube removed to illustrate internal components;

FIG. 20 is a perspective view of an example embodiment of a planter including one or more aspects of the present disclosure and configured to plant seeds in a field;

FIG. 21 is a fragmentary perspective view of one of the planting units of the planter of FIG. 20;

FIGS. 22-25 are fragmentary front views of example embodiments of seed discs of the present disclosure, each for use with a seed meter to plant seeds in a field, where the seed discs each include seed receptacles with braces (or supports) for supporting, holding, maintaining, entraining, etc. seeds on the seed disc;

FIG. 26 is a front view of an example embodiment of a seed disc of the present disclosure, for use with a seed meter to plant seeds in a field, where the seed disc includes seed receptacles with braces (or supports) for supporting, holding, maintaining, entraining, etc. seeds on the seed disc; and

FIGS. 27-29 are fragmentary front views of example embodiments of seed discs of the present disclosure, each for use with a seed meter to plant seeds in a field, where the seed discs each include seed receptacles with braces (or supports) for supporting, holding, maintaining, entraining, etc. seeds on the seed disc.

Corresponding reference numerals indicate corresponding parts throughout the several views of the drawings.

### DETAILED DESCRIPTION

Planters are often used to plant different types and/or sizes of seeds in fields. In doing so, the planters often include seed meters for dispensing the seeds from storage units into furrows created by the planters in fields. The seed meters typically include rotating seed discs having multiple separated apertures specifically sized for particular types and/or sizes of seeds (e.g., a given seed disc is typically specified (based on sizes of apertures in the seed disc) for a particular type and/or size of seed, etc.). As the seed discs rotate, within the seed meters, the apertures capture, entrain, hold, etc. individual seeds thereon via vacuum as the seeds are presented to the seed discs. The seed discs then transport the individual seeds to exit chutes of the seed meters, where they are released from the apertures and planted in the furrows. If the seed type and/or seed size being planted by the planters is changed, the seed discs are replaced with different seed discs with apertures specifically sized for the new seed type and/or seed size.

That said, agricultural seeds have a wide variety of sizes. For example, a particular seed type as well as different types of seeds often have different sizes. For instance, corn seeds of different varieties often have different sizes (e.g., the different varieties of corn seeds may each have different seed sizes, etc.). In addition, corn seeds often have different sizes than soy seeds, grain seeds, and other types of seeds, etc. When a seed meter having a rotating seed disc with separated apertures is used for planting seeds such as corn seeds in a field, smaller ones of the corn seeds may get stuck in the apertures and jam the seed meter or pass through the apertures. As a result, the apertures must be cleaned of stuck seeds thereby resulting in extended downtime and inefficiencies in the planting process. Additionally, larger ones of the corn seeds may not attach or adequately attach to (or may not be captured by) the seed disc due to a lack of sufficient vacuum strength, thereby creating inconsistencies when planting (e.g., inconsistent spacings of seeds in the furrows, etc.).

Typically, addressing these problems includes manually separating out differently sized seeds (so that only consistently sized seeds are planted at one time) and then switching between specifically designed seed discs on the fly (e.g., at the field, etc.) as the differently sized seeds are planted, where the seed discs have different sized apertures (e.g., circular holes, etc.) for the different sized seeds. For example, it may be necessary to have four or more different seed discs for sweet corn seeds alone as well as multiple other seed discs for different varieties of corn seeds other than sweet corn seeds. However, this typical approach is not efficient, particularly while in the field, as swapping out seed discs is difficult (and sometimes impossible) in some planters, and requires extended downtime and increased labor during the planting process, thereby creating inefficiencies in the process.

Uniquely, the seed discs herein include one or more bracings or supports within apertures so that differently sized seeds may be attached against the seed discs and captured (or entrained) within the apertures for planting. For example, a seed disc herein may include a plate defined by an outer perimeter and multiple seed receptacles defined in the plate and configured to capture or entrain seeds (e.g., corn seeds, soy seeds, cotton seeds, sorghum seeds, grain seeds, vegetable seeds, and/or any other suitable agricultural seeds) when the seed disc rotates. The multiple seed receptacles each include an outer edge defining an aperture and one or more supports disposed/located within the aperture (and in some embodiments generally dividing the aperture into multiple portions). In such examples, small seeds are prevented from becoming stuck in the apertures of the receptacles due to the one or more supports (or protrusions, etc.) and large seeds are able to adequately attach to the seed disc due to sufficient surface area of vacuum suction (and/or enlarged sizes of the apertures as compared to conventional seed discs). As such, the seed discs herein enable a substantially universal solution for planting various seeds of different sizes (e.g., seeds of the same type or different types, etc.) by leveraging one or more bracings, supports, protrusions, etc. within the apertures of the seed discs. In this manner, the same seed disc may be used to plant a variety of different types and/or sizes of seeds without changing to a different seed disc. This may lead to increased planting effectiveness, reliability, and efficiency (e.g., due to less planting downtime, labor, hardware, etc.) as compared to the conventional approach of sorting seeds by sizes and using multiple different seed discs for the different sizes of sorted seeds.

Example embodiments will now be described more fully with reference to the accompanying drawings. The description and specific examples included herein are intended for purposes of illustration only and are not intended to limit the scope of the present disclosure.

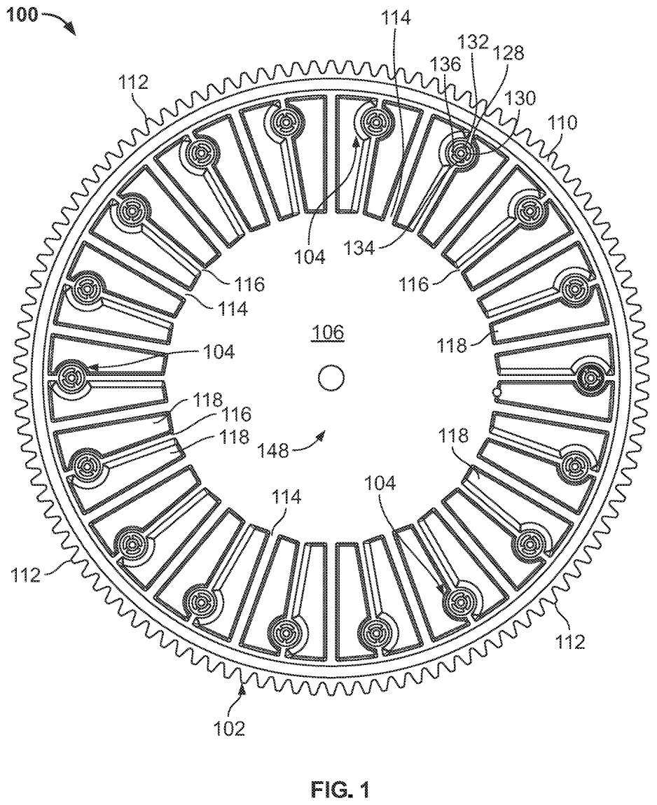

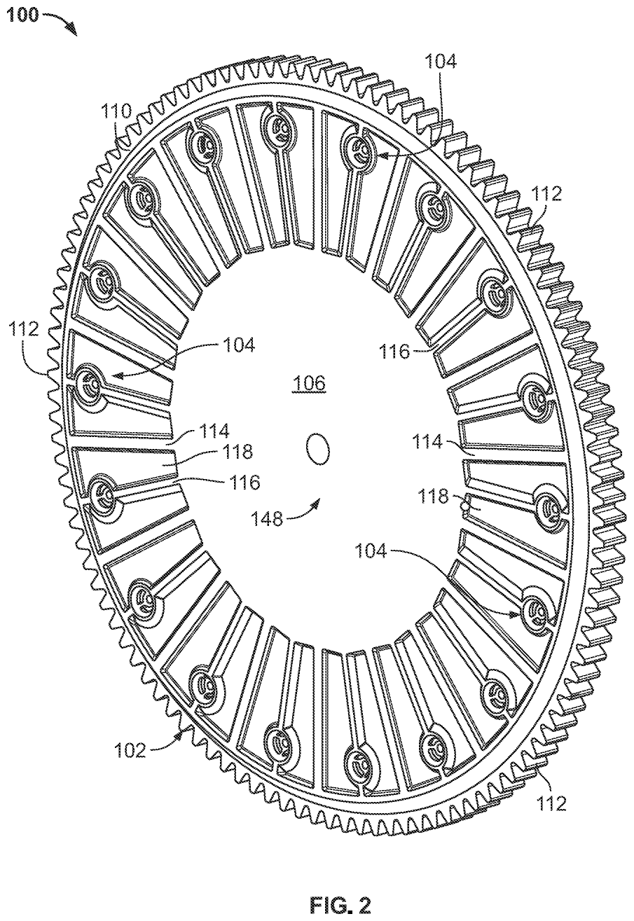

FIGS. 1-4 illustrate an example embodiment of a rotatable seed disc 100 (or seed singulator) including one or more aspects of the present disclosure. As further explained herein, the seed disc 100 of FIGS. 1-4 may be used in a desired seed meter, planting unit, planter, etc. for use in planting different types of seeds and/or seeds of different sizes in a field (e.g., different plots in the field, etc.). The illustrated seed disc 100 generally includes a plate 102 and multiple seed receptacles 104 formed in the plate 102 and configured to capture, hold, retain, entrain, etc. seeds (e.g., on the plate 102, etc.). The plate 102 generally includes opposing sides 106, 108 and an outer perimeter 110. As shown, the outer perimeter 110 of the plate 102 defines a series of teeth 112 positioned around the plate 102 to enable the seed disc 100 to function as a gear and rotate about a shaft (not shown). In the illustrated embodiment, the plate 102 of the seed disc 100 defines a generally circular shape, but could have other shapes in other embodiments.

As shown in FIGS. 1-2 and 4, the plate 102 includes various ribs 114, 116 positioned on the side 106 (e.g., a front side, etc.) of the seed disc 100. The ribs 114, 116 extend radially between a center portion 148 of the plate 102 and the outer perimeter 110. More specifically, the ribs 114 extend radially between adjacent seed receptacles 104 while the ribs 116 extend radially to and from sides of the seed receptacles 104 (e.g., generally through the receptacles, 104, etc.). The ribs 114, 116 define recesses 118 (e.g., lowered or recessed portions of the plate 102, etc.) therebetween. In some embodiments, the radially extending ribs 114, 116 may be configured (e.g., positioned, sized, etc.) to agitate seeds presented to the seed receptacles 104 when the seed disc 100 rotates (e.g., within a chamber of a seed meter, etc.), as further explained below. While the seed disc 100 is illustrated as including the ribs 114, 116, it should be appreciated that such components are not required in all embodiments. For example, in some embodiments the seed disc 100 may not include the ribs 114, 116. Additionally, in other embodiments the seed disc 100 may include the ribs 114 but not the ribs 116 or may include the ribs 116 but not the ribs 114, or may include one or more ribs with other configurations than shown in the drawings.

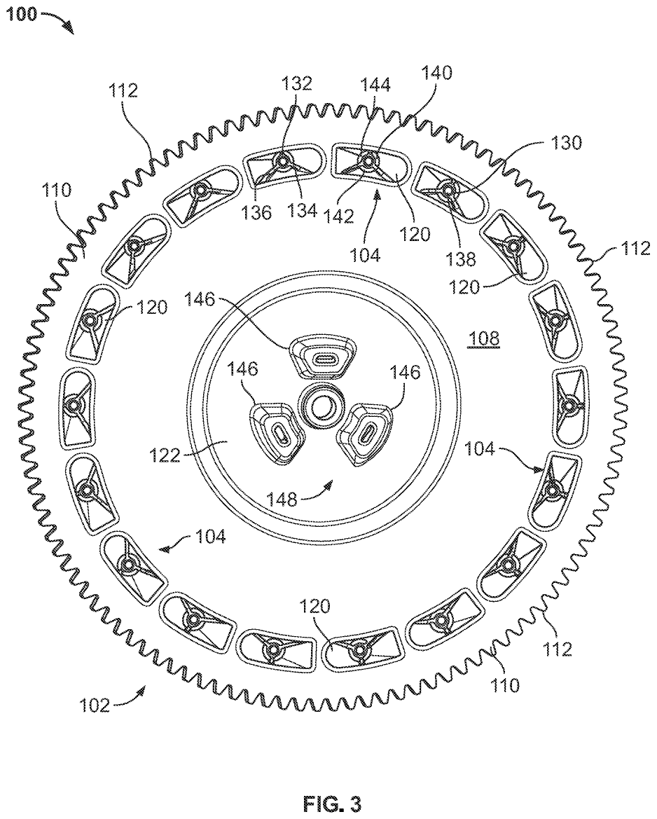

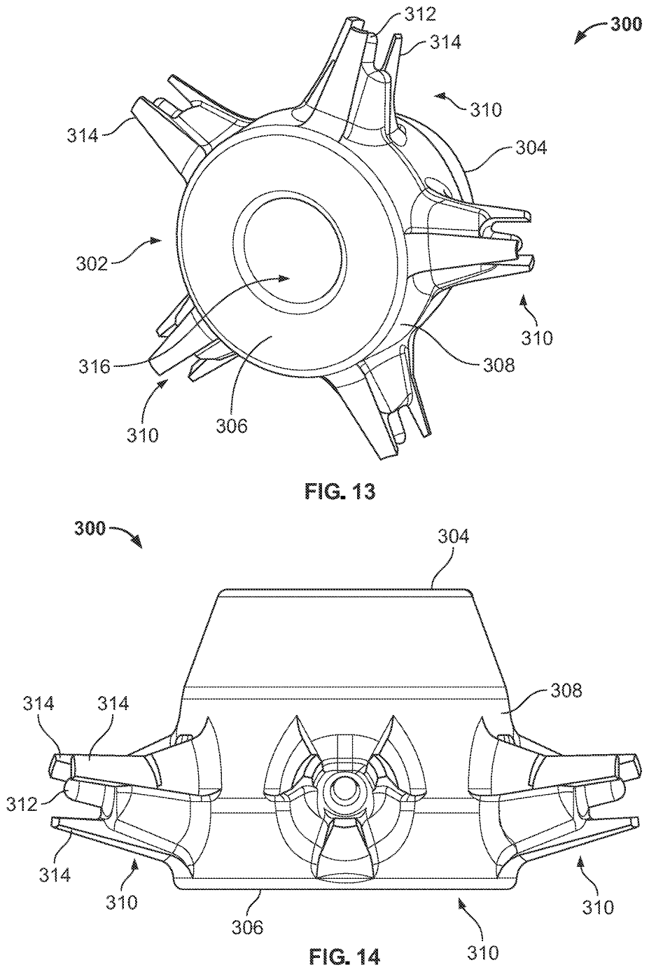

Additionally, the plate 102 defines various recesses 120, 122 on the side 108 (e.g., a backside, etc.) of the seed disc 100. For example, and as shown in FIG. 3, each recess 120 corresponds to and generally extends around each seed receptacle 104, and the recess 122 generally extends around the center portion 148 of the plate 102. In various embodiments, the recesses 120 are configured (e.g., shaped, sized, etc.) to channel a vacuum (e.g., as applied to the seed plate 102 when the seed plate 102 is included in a seed meter, etc.) effectively through apertures in the receptacles 104 (e.g., the apertures 126, 138, 140, 142, 144 in the receptacles 104 as further described below, etc.), and provide a guide for ejector spurs (e.g., ejector spurs of an ejector 300 as shown in FIGS. 13-15 and described below, etc.) to cleanly enter and exit the apertures without the spurs impacting the plate 102 and causing damage.

In the illustrated embodiment, three members 146 extend (e.g., are elevated, etc.) within the recess 122, from the side 108 of the plate 102. In some embodiments, the members 146 may provide a buffer between other components when the seed disc 100 is employed in a seed meter as further explained below. For example, the recess 122 and the members 146 may interact with a drive configured to rotate the plate 102. In such examples, the drive may include components configured to interact with the members 146 (e.g., extend between the members 146 and/or engage the members 146, etc.) for causing rotation of the plate 102. The drive may be a chain drive or another suitable device within the scope of the present disclosure. While the seed disc 100 is illustrated as including the three members 146, it should be appreciated that the seed disc 100 may include more or fewer members extending within the recess 122.

The seed receptacles 104 are spaced apart circumferentially adjacent an outer edge portion of the plate 102 and generally within (e.g., radially within, etc.) the outer perimeter 110. In the illustrated embodiment, the seed disc 100 includes eighteen seed receptacles 104 generally equally (or generally evenly) spaced apart adjacent to the outer perimeter 110. The seed receptacles 104 intersect the ribs 116 extending radially from the center portion 148 of the plate 102. Although the seed disc 100 is illustrated and described as including eighteen seed receptacles 104 arranged in a particular manner, it should be appreciated that the seed disc 100 may include more or fewer seed receptacles 104 and/or seed receptacles 104 arranged in a different manner (e.g., spaced apart in a different manner, etc.), if desired. For example, the seed disc 100 (and/or any other seed disc herein) may include any suitable number of seed receptacles such as three, six, ten, twelve, fifteen, nineteen, twenty, twenty-five, twenty-seven, thirty, thirty-six, forty, fifty, sixty, eighty, or more or less, etc. seed receptacles.

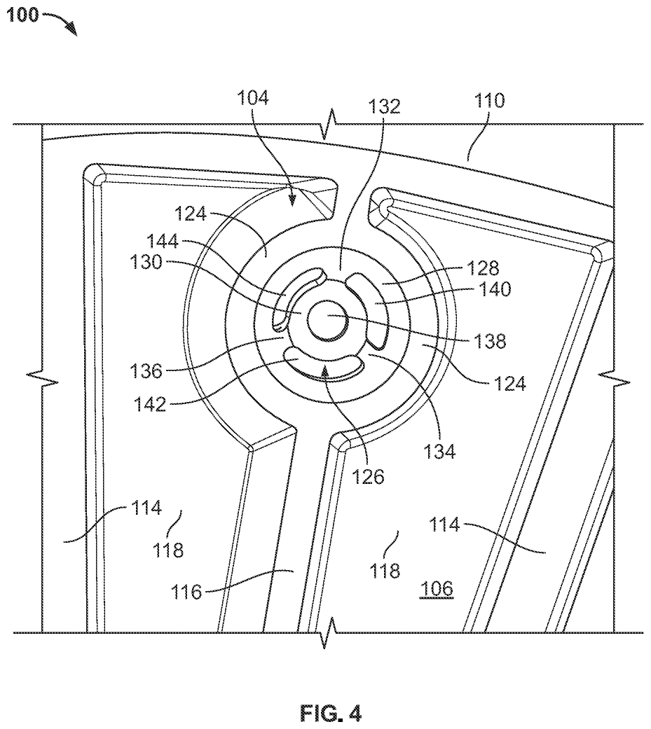

As best shown in FIG. 4, each seed receptacle 104 includes a generally arcuate (e.g., rounded, etc.) outer edge 124 defining a generally rounded aperture 126 (e.g., a main aperture, an overall aperture, an annular main aperture, etc.) extending between the sides 106, 108 of the plate 102 (e.g., generally through the plate 102, etc.) and one or more braces or supports nested or contained (broadly, disposed, located, positioned, etc.) within the outer edge 124 (broadly, within the aperture 126). In this manner, the one or more supports extend into the apertures 126 of the seed receptacles 104. Then, when the seed receptacles 104 capture, receive, entrain, etc. seeds such as small seeds (e.g., small corn seeds, soy seeds, grain seeds, etc.), the one or more supports prevent the seeds from becoming stuck in the seed receptacles 104 and/or passing through the apertures 126 of the seed receptacles 104, which may otherwise cause the seeds to jam a seed meter including the seed disc 100. While the aperture 126 of each of the seed receptacles 104 is illustrated as having a generally rounded shape, it should be appreciated that the aperture 126 of one or more of the seed receptacles 104 may have other shapes in other embodiments (e.g., generally oval shapes, generally triangular shapes, generally square shapes, generally rectangular shapes, generally hexagonal shapes, generally octagonal shapes, other shapes, etc.)

More specifically in the illustrated embodiment, each seed receptacle 104 of the seed disc 100 includes an outer support 128 (e.g., an outer annular or generally circular support, etc.) abutted against the outer edge 124, an inner support 130 (e.g., an inner annular or generally circular support, etc.) positioned within the outer support 128 (e.g., generally concentrically within the outer support 128, etc.), and three arm supports (or arms or protrusions, etc.) 132, 134, 136 generally extending radially towards a center of the aperture 126. The arm supports 132, 134, 136 extend between the outer support 128 and the inner support 130 of each seed receptacle 104 (as shown in FIGS. 1-2 and 4) and further extend (or angle) toward (e.g., to, etc.) edges of the corresponding recess 120 (as shown in FIG. 3). In other embodiments, the arm supports 132, 134, 136 may extend in one or more other directions and/or between other components and/or may have one or more other configurations. For example, some or all of the arm supports 132, 134, 136 may extend at an obtuse or acute angle relative to the outer edge 124 and not towards the center of the aperture 126. In other examples, the arm supports 132, 134, 136 may only extend between the outer support 128 and the inner support 130 of each seed receptacle 104 and not to edges of the corresponding recess 120. In still other examples, one or more of the seed receptacles 104 may include fewer than three arm supports or more than three arm supports. Further, in some examples, one or more of the seed receptacles 104 may include a different number and/or configuration of arm supports than one or more other ones of the receptacles 104.

In the illustrated embodiment, the arm supports 132, 134, 136 are generally equally spaced from each other. For example, one arm support (e.g., the arm support 132) is spaced apart from the adjacent arm supports (e.g., the arm supports 134, 136) by about 120 degrees. In other embodiments, the arm supports 132, 134, 136 may be unequally spaced from each other. For example, the arm support 132 may be spaced apart from the arm support 134 by about 90 degrees or another suitable amount and the spaced apart from the arm support 136 by about 135 degrees or another suitable amount.

As shown, in this example embodiment, the supports 128, 130, 132, 134, 136 define various inner apertures within the outer edge 124 of the receptacle 104, which generally form parts of the main aperture 126. As such, the various inner apertures may be considered portions of the main aperture (or aperture portions). For example, in the illustrated embodiment, the inner support 130 defines an inner aperture 138 (e.g., an annular or circular or rounded inner aperture, etc.) generally centered in the main aperture 126, and the supports 128, 130, 132, 134, 136 define three generally elliptically shaped outer apertures 140, 142, 144 extending generally circumferentially within the outer edge 124 (and defined within or as part of the main aperture 126). More specifically, the arm supports 132, 134 and the supports 128, 130 define the aperture 140, the arm supports 134, 136 and the supports 128, 130 define the aperture 142, and the arm supports 132, 136 and the supports 128, 130 define the aperture 142. The apertures 140, 142, 144, then, extend generally between the outer support 128 and the inner support 130.

That said, the apertures 126, 138, 140, 142, 144 of the seed receptacles 104 may be sized and/or shaped as desired, for example, to achieve the features described herein (e.g., the seed retention features, etc.). For example, the main aperture 126 of each seed receptacle 104 may have a diameter of about 0.1 inches, about 0.15 inches, about 0.16 inches, about 0.17 inches, about 0.18 inches, about 0.19 inches, about 0.2 inches, about 0.21 inches, about 0.22 inches, about 0.23 inches, about 0.24 inches, about 0.25 inches, about 0.26 inches, about 0.27 inches, about 0.28 inches, about 0.29 inches, about 0.3 inches, etc. and/or a value therebetween. Additionally, the inner aperture 138 of each seed receptacle 104 may have a diameter of about 0.04 inches, about 0.05 inches, about 0.06 inches, about 0.07 inches, about 0.08 inches, about 0.09 inches, about 0.1 inches, etc. and/or a value therebetween. Further, the apertures 140, 142, 144 each may have a major diameter of about 0.16 inches, about 0.18 inches, about 0.2 inches, about 0.22 inches, about 0.25 inches, about 0.27 inches, about 0.3 inches, and/or a value therebetween, and a minor diameter of about 0.1 inches, about 0.11 inches, about 0.12 inches, about 0.13 inches, about 0.14 inches, about 0.15 inches, about 0.16 inches, about 0.17 inches, and/or a value therebetween (e.g., a major diameter of about 0.25 inches and a minor diameter of about 0.14 inches, a major diameter of about 0.2 inches and a minor diameter of about 0.13 inches, etc.).

The apertures 138, 140, 142, 144 enable the seed receptacles 104 to adequately capture, hold, retain, entrain, etc. large seeds such as large corn seeds, etc. and control how the seeds attach to the plate 102. For example, the multiple apertures 140, 142, 144 in the seed receptacles 104 provide for a sufficient surface area of vacuum suction to ensure seeds including large seeds adequately attach to the seed receptacles 104 of the plate 102. Additionally, the apertures 138 centered in the seed receptacles 104 provide increased surface area of vacuum suction while also enabling control of how the seeds (e.g., small and large seeds, etc.) attach to the seed receptacles 104 of the plate 102. For example, with an oblong-shaped seed, the aperture 138 centered in each seed receptacle 104 provides vacuum suction and an opening sufficient to cause one of the opposing shorter ends of the oblong-shaped seed to seat into the aperture 138. In this manner, the longer ends of the oblong-shaped seed extend away (e.g., in a perpendicular direction, etc.) from the plate 102. For instance, if the oblong-shaped seed is a corn seed, the aperture 138 may be configured (e.g., shaped, sized, etc.) to cause a tip cap or a pericarp of the corn seed to seat into the apertures 138.

With continued reference to FIGS. 1-4, one or more of the supports 128, 130, 132, 134, 136 or portions thereof (of each of the seed receptacles 104) are recessed or setback in the main aperture 126. In other words, one or more of the supports 128, 130, 132, 134, 136 or portions thereof are not aligned in the same plane as the side 106 of the plate 102. For example, the outer support 128 gradually extends (e.g., generally slopes or angles inwardly, etc.) from the side 106 of the plate 102 (at the outer edge 124) towards the side 108 of the plate 102. Additionally, the inner support 130 is recessed (and generally bowl shaped, etc.) within the outer edge 124 between the sides 106, 108 such that it is located closer (e.g., adjacent, etc.) to the side 108 and further away from the side 106 of the plate 102. In various embodiments, the inner support 130 may be recessed a desired distance relative to the side 106 of the plate 102 (e.g., about 0.06 inches or more or less, etc.). Further, the arm supports 132, 134, 136 generally extend (e.g., angle downward and/or inward, etc.) between the outer edge 124 adjacent to the side 106 and the inner support 130 adjacent to the side 108 of the plate 102. In such examples, the supports 128, 130, 132, 134, 136 may create a generally parabolic (or a cup-like, a nest-like, etc.) shape for receiving a seed.

In the illustrated embodiment, the multiple seed receptacles 104 formed in the plate 102 are substantially identical with respect to the collection of supports and apertures. In other words, each of the seed receptacles 104 includes the same supports 128, 130, 132, 134, 136 and apertures 138, 140, 142, 144. Further, the configuration of the supports 128, 130, 132, 134, 136 and the apertures 138, 140, 142, 144 of each seed receptacle 104 is substantially the same radially around the center portion 148 of the plate 102. For example, the aperture 142 of each seed receptacle 104 is positioned closer to the center portion 148 (in the radial direction) than the apertures 138, 140, and the apertures 138, 140 of each seed receptacle 104 are positioned closer to the outer perimeter 110 (in the radial direction) than the aperture 142. That said, it should be appreciated that the seed disc 100 may include one or more seed receptacles having different (non-identical) arrangements of supports and/or apertures in other embodiments.

Additionally, while the seed disc 100 is illustrated and described as including a specific number of particularly shaped supports (e.g., three generally rectangular shaped arm supports 132, 134, 136, outer and inner supports 128, 130, etc.) arranged in a particular manner, it should be appreciated that the seed receptacles 104 may include more or fewer supports and/or supports of different shapes. For example, some or all of the seed receptacles 104 may include two arm supports, four arm supports, trapezoidal shaped arm supports, triangular shaped arm supports, oval-shaped inner and/or outer supports, etc. Additionally, in some embodiments, the outer support 128 may be omitted and/or formed as part of the outer edge 124. In such examples, the arm supports 132, 134, 136 may extend between the outer edge 124 and the inner support 130. Further, some of the supports may be aligned in the same plane as the side 106 and/or the side 108 of the plate 102. What's more, in some embodiments, some or all of the seed receptacles 104 may include a set of supports (e.g., three supports, four supports, etc.) extending across and intersecting within the main aperture 126.

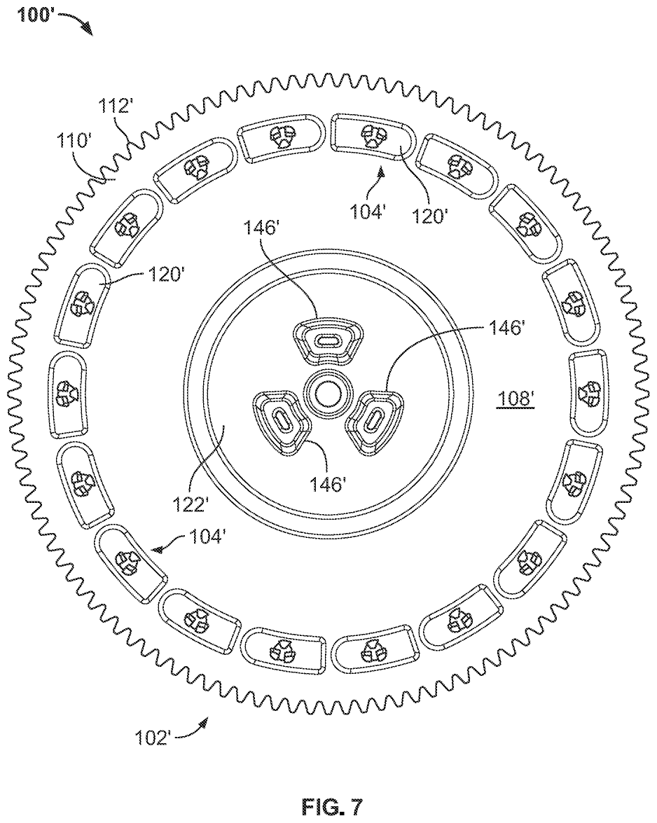

FIGS. 5-7 illustrate another example embodiment of a rotatable seed disc 100′ (or seed singulator) including one or more aspects of the present disclosure. The seed disc 100′ of FIGS. 5-7 is substantially similar to the seed disc 100 of FIGS. 1-4. For example, the seed disc 100′ generally includes a plate 102′ having opposing sides 106′, 108′ and outer perimeter 110′ defining teeth 112′. Further, the plate 102′ includes ribs 114′, 116′ on the side 106′ (e.g., a front side, etc.) of the seed disc 100′, and recesses 120′, 122′ and members 146′ on the side 108′ (e.g., a backside, etc.) of the seed disc 100′. While the seed disc 100′ is illustrated as including the ribs 114′, 116′, it should be appreciated that such components are not required in all embodiments. For example, in some embodiments the seed disc 100′ may not include the ribs 114′, 116′, include the ribs 114′ but not the ribs 116′ or include the ribs 116′ but not the ribs 114′. Further, although the seed disc 100′ is illustrated as including the three members 146′, it should be appreciated that the seed disc 100′ may include more or fewer members extending within the recess 122′.

In the illustrated embodiment, the seed disc 100′ includes seed receptacles 104′ having a different configuration than the seed receptacles 104 of FIGS. 1-4. Although the seed receptacles 104′ of this embodiment have a different configuration than the seed receptacles 104, the seed receptacles 104′ function and are positioned in a similar manner as the seed receptacles 104. For example, the seed receptacles 104′ of this embodiment are configured to capture, hold, retain, entrain, etc. seeds (e.g., on the plate 102′, etc.), and control how the seeds attach to the plate 102′, as explained above. Additionally, the seed receptacles 104′ are generally equally (or generally evenly) spaced apart circumferentially within (e.g., radially within, etc.) the outer perimeter 110′. Further, while the seed disc 100′ is illustrated as including eighteen seed receptacles 104′ arranged in a particular manner, it should be appreciated that the seed disc 100′ may include more or fewer seed receptacles 104′ and/or seed receptacles 104′ arranged in a different manner (e.g., spaced apart in a different manner, etc.), if desired.

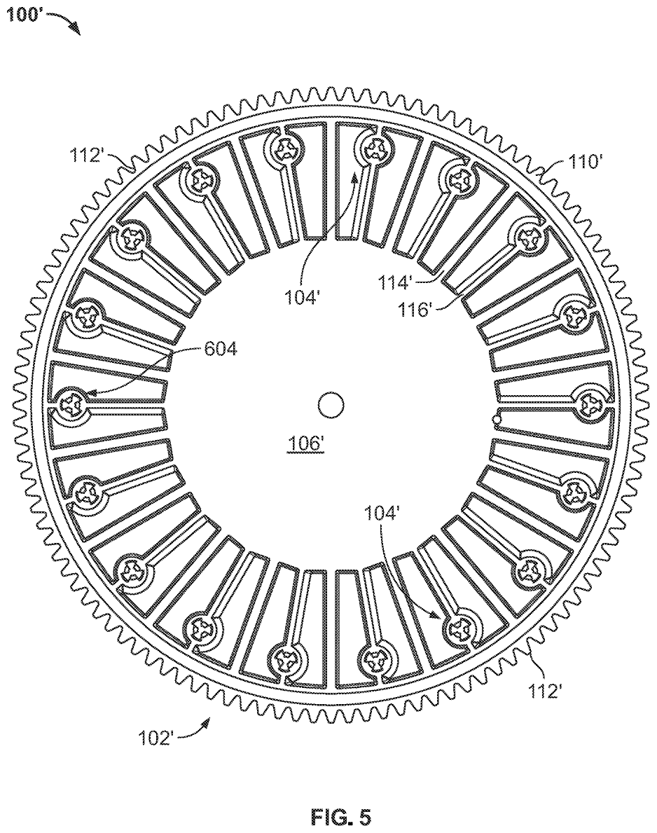

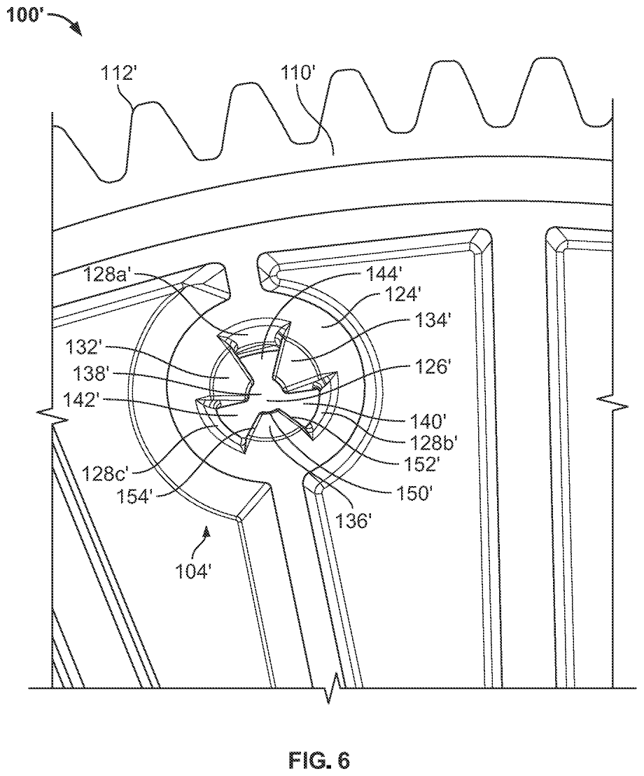

As best shown in FIG. 6, each seed receptacle 104′ includes a generally arcuate (e.g., rounded, etc.) outer edge 124′ defining an aperture 126′ (e.g., a main aperture, an overall aperture, etc.) extending between the sides 106′, 108′ of the plate 102′ (e.g., generally through the plate 102′, etc.) and one or more braces, supports, protrusions nested or contained (broadly, disposed, located, positioned, etc.) within the outer edge 124′ (broadly, within the aperture 126′). In this manner, the one or more supports (or braces or protrusions, etc.) extend into the apertures 126′ of the seed receptacles 104′. Then, when the seed receptacles 104′ capture, receive, entrain, etc. seeds such as small seeds (e.g., small corn seeds, soy seeds, grain seeds, etc.), the one or more supports prevent the seeds from becoming stuck in the seed receptacles 104′ and/or passing through the apertures 126′ of the seed receptacles 104′, as explained above.

More specifically in the illustrated embodiment, each seed receptacle 104′ of the seed disc 100′ includes three outer support portions 128a′-128c′ (e.g., outer arcuate supports, etc.) abutted against the outer edge 124′, and three arm supports (or arms or protrusions, etc.) 132′, 134′, 136′ generally extending radially from the outer edge 124′ towards a center of the aperture 126′. The arm supports 132′, 134′, 136′ are generally equally spaced from each other and circumferentially around the aperture 126′. In other embodiments, the arm supports 132′, 134′, 136′ may extend in one or more other directions and/or between other components and/or may have one or more other configurations (e.g., shapes, sizes, orientations, etc.). For example, some or all of the arm supports 132′, 134′, 136′ may extend at an obtuse or acute angle relative to the outer edge 124′ and not towards the center of the aperture 126′. In other examples, one or more of the seed receptacles 104′ may include fewer than three outer supports and/or arm supports or more than three outer supports and/or arm supports. In yet other embodiments, the arm supports 132′, 134′, 136′ may be unequally spaced from each other. Further, in some examples, one or more of the seed receptacles 104′ may include a different number and/or configuration of arm supports than one or more other ones of the receptacles 104′.

In the illustrated embodiment, the arm supports 132′, 134′, 136′ define various inner aperture portions within the outer edge 124′ of the receptacle 104′, which generally form parts of the aperture 126′. As such, the various inner apertures portions may be considered portions of the main aperture 126′. For example, and as best shown in FIG. 6, the arm supports 132′, 134′, 136′ at least partially define an aperture portion 138′ (e.g., an annular aperture portion, etc.) and generally trapezoidal aperture portions 140′, 142′, 144′ of the aperture 126′. More specifically, in the illustrated embodiment each arm support 132′, 134′, 136′ has a generally trapezoidal shape with a rounded or curved (or arcuate) end 150′, and opposing sides 152′, 154′ extending between the outer edge 124′ and the curved end 150′ and towards each other (e.g., nonparallel extending sides, etc.). In such examples, the curved ends 150′ of the arm supports 132′, 134′, 136′ at least partially define the aperture portion 138′, and the sides 150′, 152′ of the arm supports 132′, 134′, 136′ at least partially define the trapezoidal aperture portions 140′, 142′, 144′. For example, one side (e.g., the side 154′, etc.) of one arm support (e.g., the arm support 136′) and one side (e.g., the side 152′, etc.) of an adjacent arm support (e.g., the arm support 132′) at least partially define one trapezoidal aperture portion (e.g., the annular aperture portion 142′, etc.). While the aperture portions 138′, 140′, 142′, 144′ and/or the arm supports 132′, 134′, 136′ are described and shown having a particular size and shape, the aperture portions and/or the arm supports of the seed receptacles 104′ may be sized and/or shaped as desired, for example, to achieve the features described herein (e.g., the seed retention features, etc.).

With continued reference to FIGS. 5-7, one or more of the supports 128a′-128c′, 132′, 134′, 136′ or portions thereof (of each of the seed receptacles 104′) are recessed or setback in the main aperture 126′, such that one or more of the supports or portions thereof are not aligned in the same plane as the side 106′ of the plate 102′. For example, and as best shown in FIG. 6, the outer supports 128a′-128c′ and the arm supports 132′, 134′, 136′ gradually extend (e.g., generally slopes or angles inwardly, etc.) from the side 106′ of the plate 102′ (at the outer edge 124′) towards the side 108′ of the plate 102′. In such examples, portions of the arm supports 132′, 134′, 136′ are recessed within the outer edge 124′ between the sides 106′, 108′ of the plate 102′, and create a generally parabolic (or a cup-like, a nest-like, etc.) shape for receiving a seed.

While the seed disc 100′ is illustrated and described as including a specific number of particularly shaped supports arranged in a particular manner, it should be appreciated that the seed receptacles 104′ may include more or fewer supports and/or supports of different shapes.

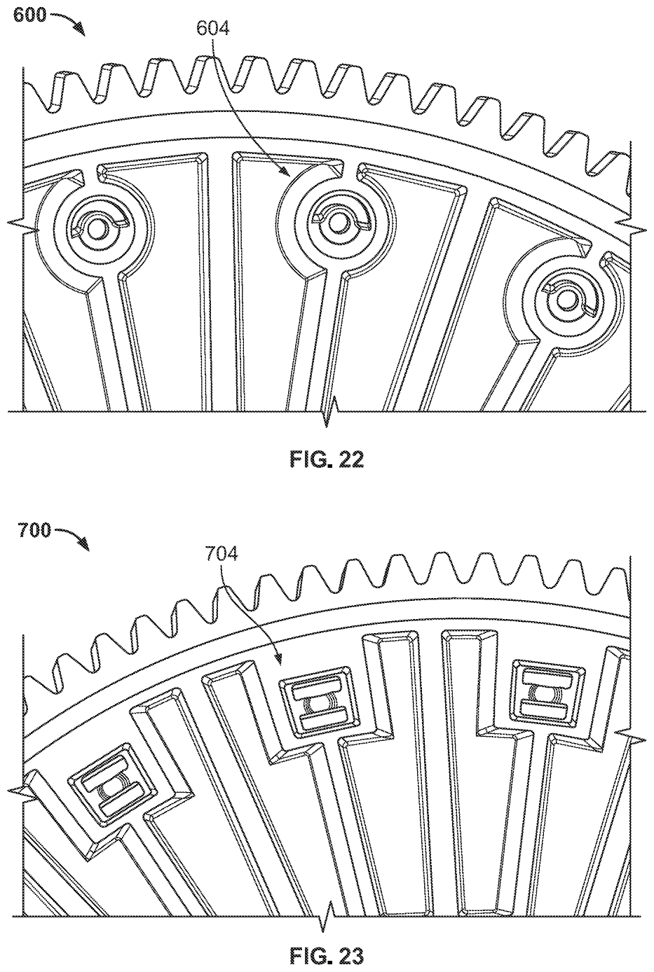

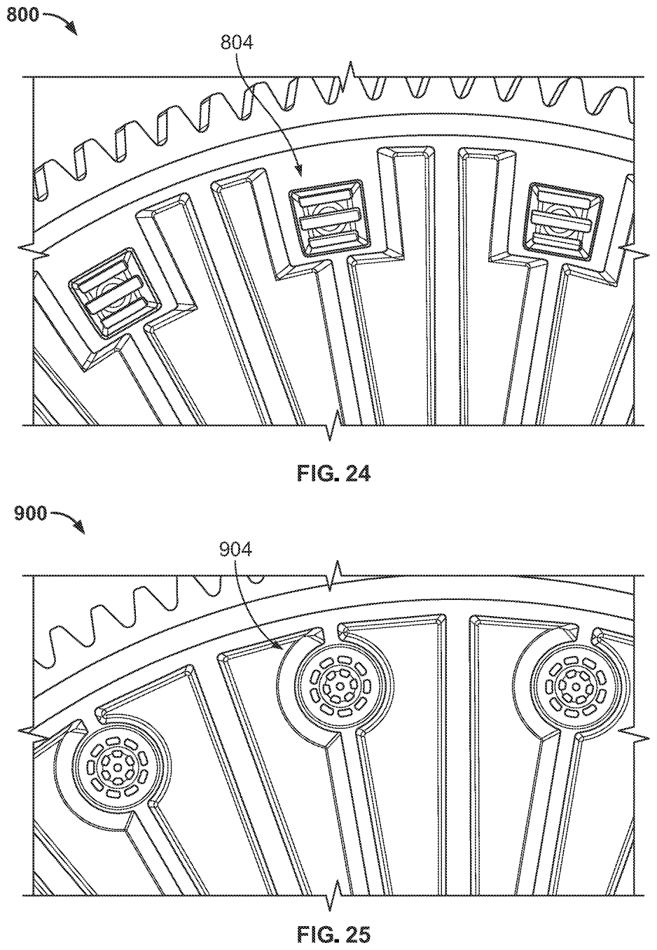

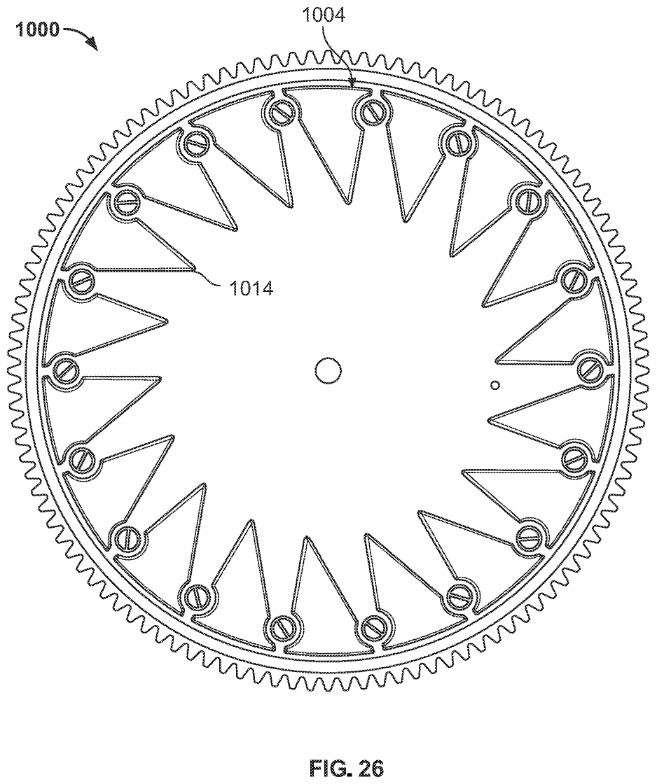

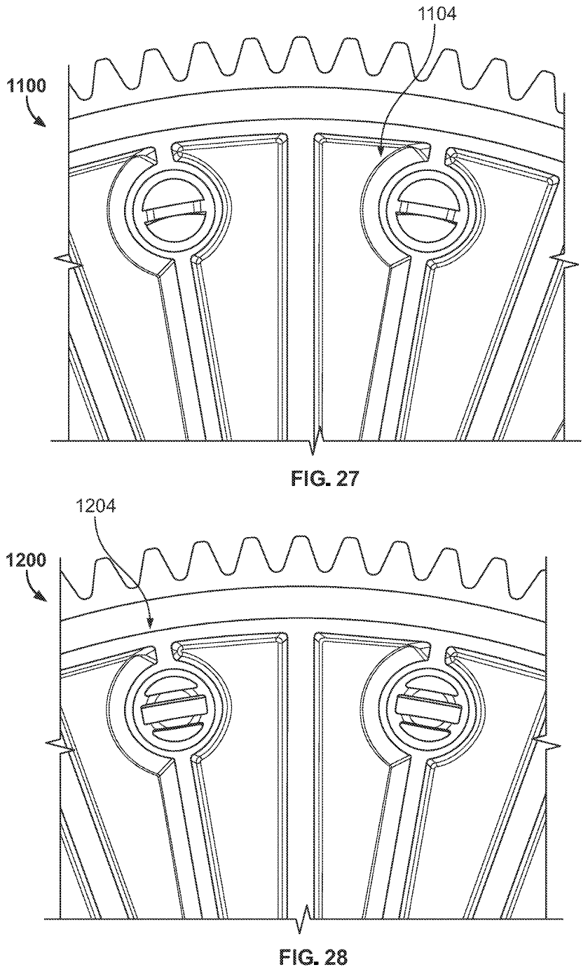

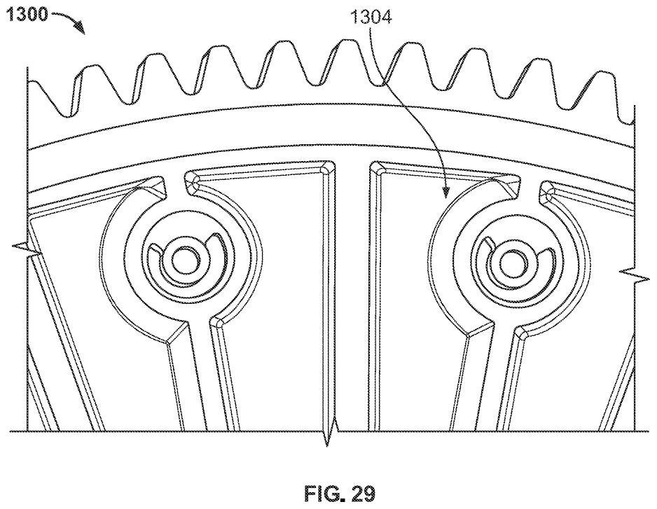

FIGS. 22-29 illustrate further example embodiments of rotatable seed discs 600-1300 (or seed singulators) including one or more aspects of the present disclosure. The seed discs 600-1300 of FIGS. 22-29 are each substantially similar to the seed disc 100 of FIGS. 1-4 and seed disc 100′ of FIGS. 5-7. For example, each of the seed discs 600-1300 generally includes a plate having opposing sides and an outer perimeter defining teeth. Further, the plate includes ribs on a first side (e.g., a front side, etc.) (e.g., ribs 1014 of seed disc 1000, etc.) of the seed disc 600-1300, and recesses on an opposite side (e.g., a backside, etc.).

In the illustrated embodiments, each of the seed discs 600-1300 include seed receptacles (identified, respectively, at 604-1304), with the receptacles 604-1304 each having a different configuration than the seed receptacles 104 of FIGS. 1-4 and the seed receptacles 104′ of FIGS. 5-7. That said, although the seed receptacles 604-1304 have different configurations than the seed receptacles 104, for example, they function and are positioned in a similar manner as the seed receptacles 104. For example, the seed receptacles 604-1304 are configured to capture, hold, retain, entrain, etc. seeds (e.g., on the plate of the respective seed disc 600-1300, etc.), and control how the seeds attach to the plate, as explained above. Additionally, the seed receptacles 604-1304 are generally equally (or generally evenly) spaced apart circumferentially within (e.g., radially within, etc.) the outer perimeter of the given seed discs 600-1300. Further, the seed receptacles 604-1304 each generally include an outer edge (e.g., defining a generally arcuate or rounded receptacle shape, a generally rectangular or square receptacle shape, a generally triangular receptacle shape, etc.) defining an aperture (e.g., a main aperture, an overall aperture, etc.) extending through the plate and one or more braces, supports, protrusions, etc. nested or contained (broadly, disposed, located, positioned, etc.) within the outer edge (broadly, within the aperture). In this manner, in various ones of the embodiments, the one or more supports (or braces or protrusions, etc.) extend into the apertures of the seed receptacles 604-1304. Then, when the seed receptacles 604-1304 capture, receive, entrain, etc. seeds such as small seeds (e.g., small corn seeds, soy seeds, grain seeds, etc.), the one or more supports prevent the seeds from becoming stuck in the seed receptacles 604-1304 and/or passing through the apertures of the seed receptacles 604-1304, as explained above.

As described, the seed discs herein (e.g., the seed disc 100 of FIGS. 1-4, the seed disc 100′ of FIGS. 5-7, the seed discs 600-1300 of FIGS. 22-29, etc.) may be used in a desired seed meter, planting unit, planter, etc. for use in planting different types of seeds and/or seeds of different sizes in a field (e.g., different plots in the field, etc.). Such seeds may vary in size. For example, thicknesses of such seeds may range from about 0.1 inches to about 0.5 inches, widths of such seeds may range from about 0.1 inches to about 0.5 inches, and lengths of such seeds may range from about 0.2 inches to about 0.6 inches (with the various different sizes of the seeds still capable of use with the given seed discs herein).

In various embodiments, the seed discs disclosed herein (including the seed discs 100, 100′) may be employed in a seed meter of a planter configured to plant seeds in a field. In such examples, the seed meter may include, for example, one of the seed discs 100, 100′ of FIGS. 1-7 or one of the seed discs 600-1300 of FIGS. 22-29 and a rotatable drum operatively coupled to the seed disc 100, 100′, 600-1300 (via a drive as described above) and including at least one seed pocket configured to hold seeds. The at least one seed pocket may include an opening configured to present the seeds to the seed disc 100, 100′, 600-1300, and the multiple receptacles 104, 104′, 604-1304 of the seed disc 100, 100′, 600-1300 are configured to capture, receive, hold, retain, entrain, etc. individual ones of the seeds in the opening as the seeds are presented to the seed disc 100, 100′, 600-1300 when the seed disc 100, 100′, 600-1300 rotates. Various examples of seed meters suitable for employing the seed disc 100 and/or the seed disc 100′ and/or the seed discs 600-1300 can be found in, for example, Applicant's co-owned U.S. Pat. No. 10,159,176 and U.S. Publication No. 2020/0329629, the entire disclosures of which are incorporated herein by reference.

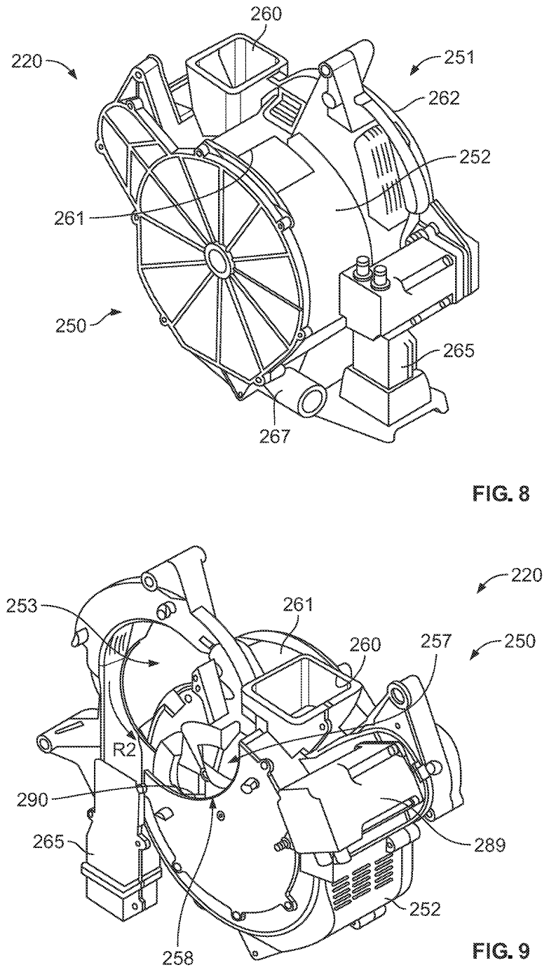

FIGS. 8-12 illustrate an example embodiment of a seed meter 220 including one or more aspects of the present disclosure. As further explained herein, the seed meter 220 of FIGS. 8-12 may be used in a desired planting unit, planter, etc. for use in planting seeds of different types and/or sizes in a field (e.g., different plots in the field, etc.).

As shown in FIGS. 8-12, the seed meter 220 generally includes a seed handler portion 250 and a seed separator portion 251. As will be described, the seed handler portion 250 is generally configured to receive and stage seeds from one or more seed storage units (not shown) in preparation for planting. And, the seed separator portion 251, then, is generally configured to isolate/singulate (broadly, meter) individual ones of the received seeds and direct them for planting.

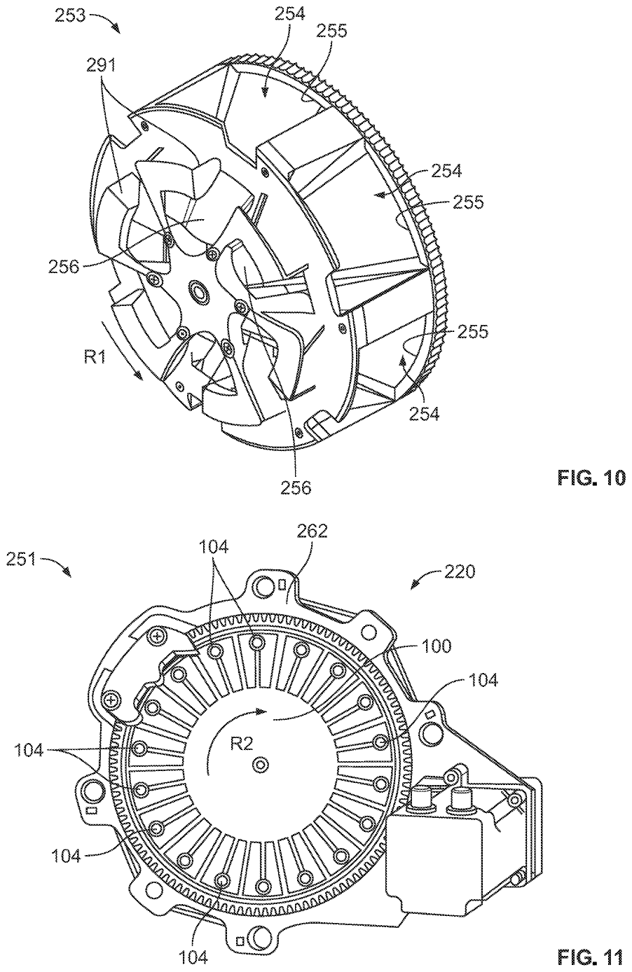

The seed handler portion 250 of the seed meter 220 includes a housing 252, and a drum 253 disposed within the housing 252. The drum 253 includes multiple seed pockets 254 (see FIG. 10) each configured to hold multiple seeds (e.g., a group or set of seeds received from the one or more seed storage units, etc.). Each of the seed pockets 254 includes a generally funnel shape, having an upper opening 255 (for receiving seeds into the seed pocket 254) and a lower opening 256 (for dispensing seeds from the seed pocket 254, for example, to the seed separator portion 251 during planting operation). As such, upon receiving seeds into one of the seed pockets 254 through the upper opening 255 (when the seed pockets 254 are generally vertically oriented), the seeds fall (e.g., via gravity, forced air, etc.) to the lower opening 256 where they are subsequently presented to the seed separator portion 251 for singulation and planting. In the illustrated embodiment, the drum 253 includes six seed pockets 254. In other embodiments, however, the drum 253 may include more than six or fewer than six seed pockets (e.g., two seed pockets, four seed pockets, five seed pockets, eight seed pockets, etc.).

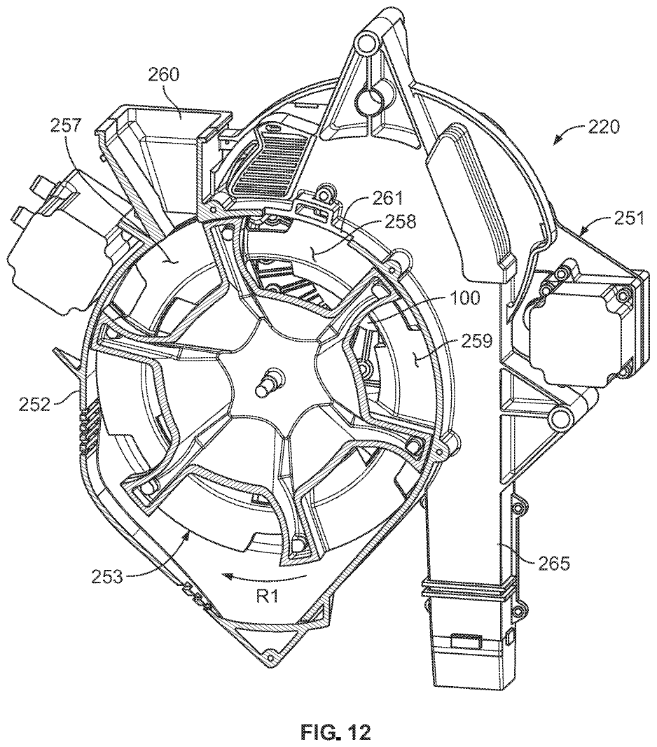

As best shown in FIG. 12, the housing 252 of the seed handler portion 250 also generally defines several different chambers therein, through which the drum 253 is configured to rotate during operation of a planting unit. In particular, the housing 252 defines a staging chamber 257, a planting (or metering) chamber 258, and an evacuation chamber 259. The drum 253, then, is configured to rotate (in direction R1 in FIGS. 10 and 12) within the housing 252 (in a suitable manner, for example, via a motor 289), and move each of the seed pockets 254, one at a time, between these chambers 257, 258, 259. In connection therewith, the housing 252 also includes a staging inlet 260 in communication with the staging chamber 257 for receiving seeds from the one or more seed storage units into the staging chamber 257 (e.g., into a seed pocket 254 of the drum 253 located, positioned, aligned, etc. in/with the staging chamber 257, etc.). The housing 252 additionally includes a planting inlet 261 in communication with the planting chamber 258 for receiving seeds from the one or more seed storage units into the planting chamber 258, when desired (e.g., into a seed pocket 254 of the drum 253 located, positioned, aligned, etc. in/with the planting chamber 258), and thereby directly into the planting chamber 258 (e.g., and thereby generally bypassing the staging chamber 257, etc.).

In the illustrated embodiment, the drum 253 is configured to rotate within the housing 252 in increments of about sixty degrees, from one station/position to a next station/position, to account for the six seed pockets 254. In other embodiments, however, the drum 253 may be configured to rotate in other increments, for example, based on a number of seed pockets included in the drum 253, a number and/or location of desired positions of the drum 253 within the seed meter 220, a number and/or location of desired chambers within the seed meter 220, etc.

With continued reference to FIGS. 8-12, the seed separator portion 251 of the seed meter 220 includes a housing 262, and the seed disc 100 (or seed singulator), for example, of FIGS. 1-4 disposed within the housing 262 (where the housing 262 is then coupled to the housing 252 of the seed handler portion 250). The seed disc 100 is configured to rotate generally within the housing 262 (in direction R2 (FIGS. 9 and 11)) to singulate and parse a stipulated, or predetermined, number of seeds from those presented (or delivered) to the seed disc 100 at the planting chamber 258 (e.g., by one of the seed pockets 254 of the drum 253, directly from the planting inlet 261, etc.). In particular and as explained above, the multiple seed receptacles 104 of the seed disc 100 (see FIG. 11 illustrating the seed receptacles 104 without the supports for clarity) are configured to entrain individual seeds thereon (e.g., via vacuum, etc.) as the seeds are presented to the planting chamber 258, through extraction window 290 (located generally between the seed handler portion 250 and the seed separator portion 251 of the seed meter 220) (FIG. 9). The seed disc 100 is configured to then transport the individual seeds to an exit chute 265 where they are dislodged (in a suitable manner, for example, via wipers 291) and planted in a corresponding furrow (generally one-by-one, based on the singulation operation of the seed disc 100) via a planting tube of a planting unit. And, when the planting operation is complete for the given seeds in the planting chamber 258 (e.g., in the given seed pocket 254 positioned at the planting chamber 258, etc.), the remainder of the seeds in the seed pocket 254 not planted/deposited is removed from the seed pocket 254 at the evacuation chamber 259 via an evacuation nozzle 267 (upon movement of the seed pocket 254 by the drum 253 to the evacuation chamber 259).

Although the seed meter 220 of FIGS. 8-12 is described and shown as including the seed disc 100, it should be appreciated the seed meter 220 may instead include the seed disc 100′ or another suitable seed disc (e.g., one of seed discs 600-1300, etc.) to achieve the features described herein (e.g., the seed retention features, etc.). Additionally, it should be appreciated that other seed meters may be used with a planter (and planting units thereof) within the scope of the present disclosure (and include the seed disc 100, the seed disc 100′, the seed discs 600-1300, etc.). In connection therewith, the seed meters may include/define any desired number and/or configuration of chambers (i.e., the particular number and arrangement of chambers described herein for the seed meter 220 should not be considered a limiting feature of the present disclosure). For example, seed meters having a single planting chamber may be used, whereby seeds from the one or more seed storage units may be delivered to the single chamber (or may bypass the chamber all together and be delivered directly to a planting tube), as desired, by way of the teachings herein. Similarly, seed meters having more than one chamber (i.e., a planting chamber and at least one additional chamber) may be used, again whereby seeds from the one or more seed storage units may be delivered to select ones of the particular chambers (or may bypass the chambers all together), as desired, by way of the teachings herein.

In various embodiments, the seed meters disclosed herein may include an apparatus configured to clean (e.g., remove, dislodge, etc.) seeds and/or debris from seed receptacles of a seed disc. For example, FIGS. 13-15 illustrate an example embodiment of an ejector 300 including one or more aspects of the present disclosure. As further explained herein, the ejector 300 may be included in a seed meter (e.g., in the seed meter 220 of FIGS. 8-12 (e.g., adjacent the evacuation chamber 259, etc.), etc.) and is configured to clean debris from seed receptacles of a seed disc (e.g., the seed receptacles 104 of the seed disc 100 shown in FIGS. 1-4, etc.) as the seed disc rotates in the seed meter.

As shown, the ejector 300 generally includes a body 302 and spurs 310 extending from the body 302. The spurs 310 generally have a shape corresponding to a shape of the seed receptacles (e.g., the seed receptacles 104 of FIGS. 1-4, the seed receptacles 104′ of FIGS. 5-7, etc.). And, the spurs 310 or portions thereof are configured to extend (at least partially) into the seed receptacles. In this manner, the spurs 310 can dislodge seeds and/or debris from the seed receptacles if such objects are present.

The body 302 of the ejector 300 generally includes two opposing ends or sides 304, 306 and a rounded or curved (or arcuate) side 308 extending between the ends 304, 306. In the illustrated embodiment, the ends 304, 306 extend in generally parallel planes. Additionally, the side 308 defines a channel 316 extending between the ends 304, 306 for receiving a shaft (not shown) in which the ejector 300 rotates about as further explained below.

The spurs 310 of the ejector 300 extend from the side 308 of the body in a generally perpendicular direction. In the illustrated embodiment, the ejector 300 include five substantially identical spurs 310 generally equally spaced about the side 308. In other embodiments, the ejector 300 may include more or fewer spurs (e.g., two spurs, three spurs, four spurs, six spurs, seven spurs, nine spurs, etc.) and/or non-identical spurs without departing from the scope of the present disclosure.

Each spur 310 includes various protrusions extending from the side 308 for insertion into corresponding apertures of the seed receptacles of the seed disc. More specifically in the illustrated embodiment, each spur 310 includes one inner protrusion 312 and three outer protrusions 314 equally spaced about the inner protrusion 312. In this example embodiment, the one inner protrusion 312 and the three outer protrusions 314 correspond to (or align with) and are configured to at least partially penetrate the apertures 138, 140, 142, 144 of the seed receptacles 104 of the seed disc 100 of FIGS. 1-4. In such examples, the inner protrusion 312 has a generally circular cross-sectional shape corresponding in size to the aperture 138 and the outer protrusions 314 have a generally arcuate cross-sectional shape corresponding in size to the apertures 140, 142, 144. In other embodiments, the number, arrangement, size, etc. of the protrusions of each spur 310 may differ depending on, for example, the number, arrangement, size, etc. of the apertures in the seed receptacles of the corresponding seed disc with which the ejector 300 will be used.

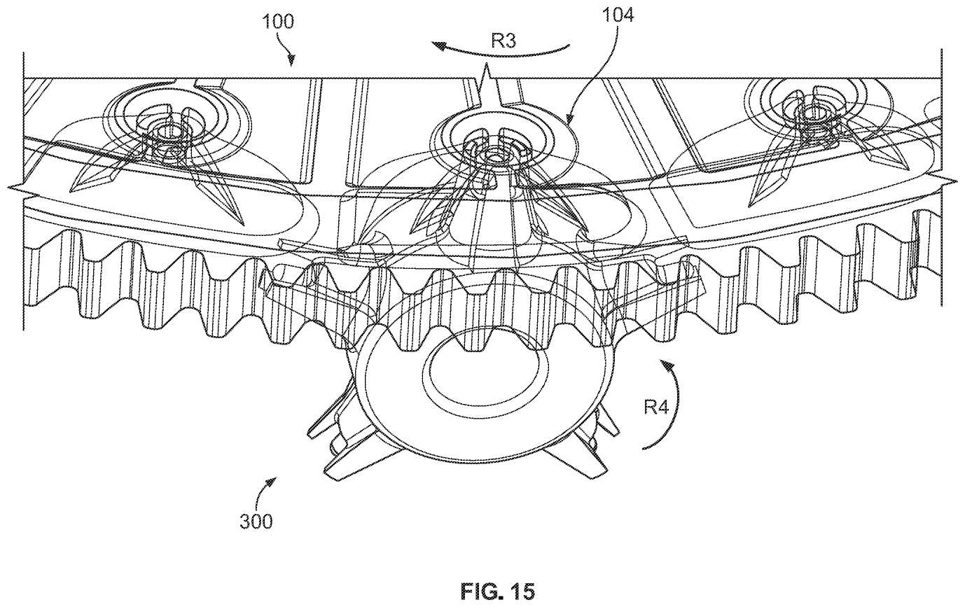

That said, the ejector 300 may be operatively coupled to a seed disc via the spurs 310 (and corresponding receptacles of the seed disc). For example, and as shown in FIG. 15, the ejector 300 may operatively couple to the seed disc 100 of FIGS. 1-4 by way of the receptacles 104 of the seed disc 100 (and corresponding spurs 310 of the ejector 300). In such example, the ejector 300 may be part of a seed meter including the seed disc 100, such as the seed meter 220 of FIGS. 8-12. During operation, then, the seed disc 100 rotates (e.g., in the direction R3 in FIG. 15 (or in the direction R2 in FIGS. 9 and 11) or an opposite direction, etc.), whereby individual seeds are entrained in the seed receptacles 104 and then transported to an exit chute of the seed meter (e.g., the exit chute 256 of the seed meter 220, etc.), as explained above. During this time, the ejector 300 also rotates in a plane that is generally perpendicular to the seed disc 100 (e.g., in the direction R4 in FIG. 15 or an opposite direction, etc.) such that individual spurs 310 align with individual seed receptacles 104 as the seed disc 100 and the ejector 300 rotate. In doing so, the protrusions 312, 314 of the individual spurs 310 align with and at least partially penetrate the apertures 138, 140, 142, 144 of the individual seed receptacles 104 of the seed disc 100, after the individual seeds are released to the exit chute of the seed meter, thereby dislodging and cleaning any seeds (or portions thereof) and/or any debris from (or remaining in) the seed receptacles 104 of the seed disc 100.

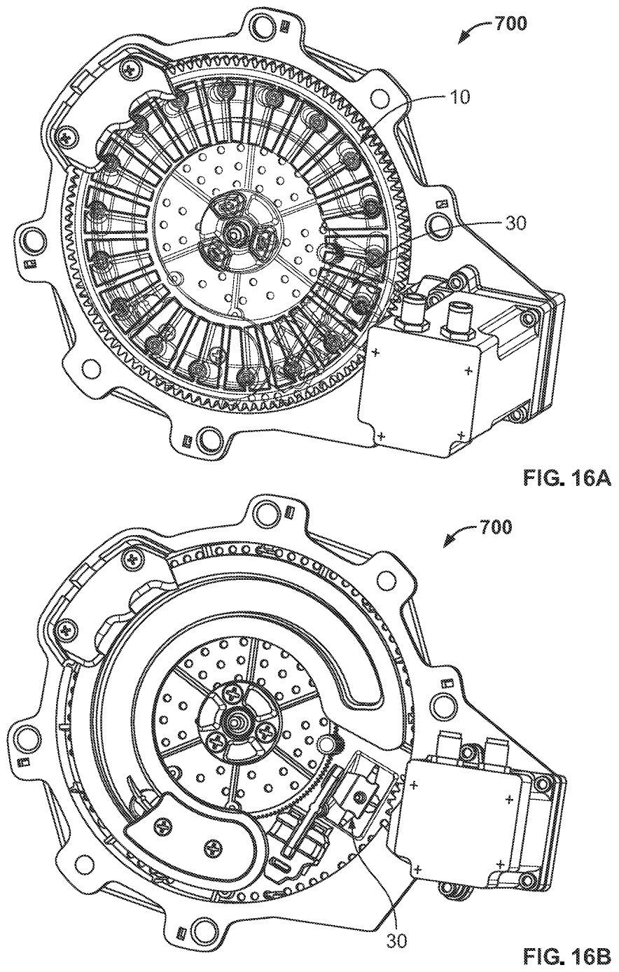

FIGS. 16A-16B illustrate another example embodiment of a seed meter 700 including one or more aspects of the present disclosure. As further explained herein, the seed meter 700 of FIGS. 16A-16B may be used in a desired planting unit, planter, etc. for use in planting seeds of different types and/or sizes in a field (e.g., different plots in the field).

The seed meter 700 is similar to the seed meter 220 described with reference to FIGS. 8-12 (such that the above description of the seed meter 220 (and the corresponding parts therein) generally applies to the seed meter 700). For example, the seed meter 700 of FIGS. 16A-16B generally includes a seed disc 10 (or seed singulator) and an ejector 30, both of which function in a similar manner as the seed discs 100, 100′ of FIGS. 1-7 (and the seed discs 600-1300 of FIGS. 22-29) and the ejector 300 of FIGS. 13-15. For instance, the ejector 30 is configured to clean debris from seed receptacles of the seed disc 10 as the seed disc 10 rotates in the seed meter 700.

In the illustrated embodiment of FIGS. 16A-16B, the seed disc 10 and its corresponding ejector 30 are generically shown for clarity and simplicity. Specifically, in FIGS. 16A-B, the seed disc 10 is shown as including multiple seed receptacles each with one opening and the ejector 30 is shown as including multiple spurs each with one protrusion. Although the seed meter 700 of FIGS. 16A-16B is described and shown as including the generic seed disc 10 and ejector 30, it should be appreciated the seed meter 700 may instead include the seed disc 100 of FIGS. 1-4 and the ejector 300 of FIGS. 13-15, or the seed disc 100′ of FIGS. 5-7 and a corresponding ejector, or another suitable seed disc and ejector (such as one of the seed discs 600-1300).

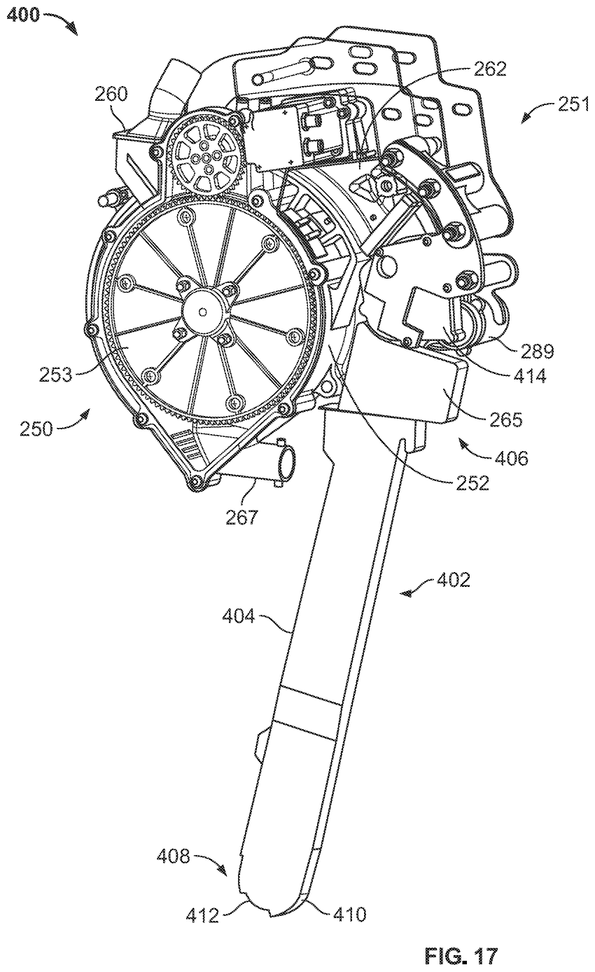

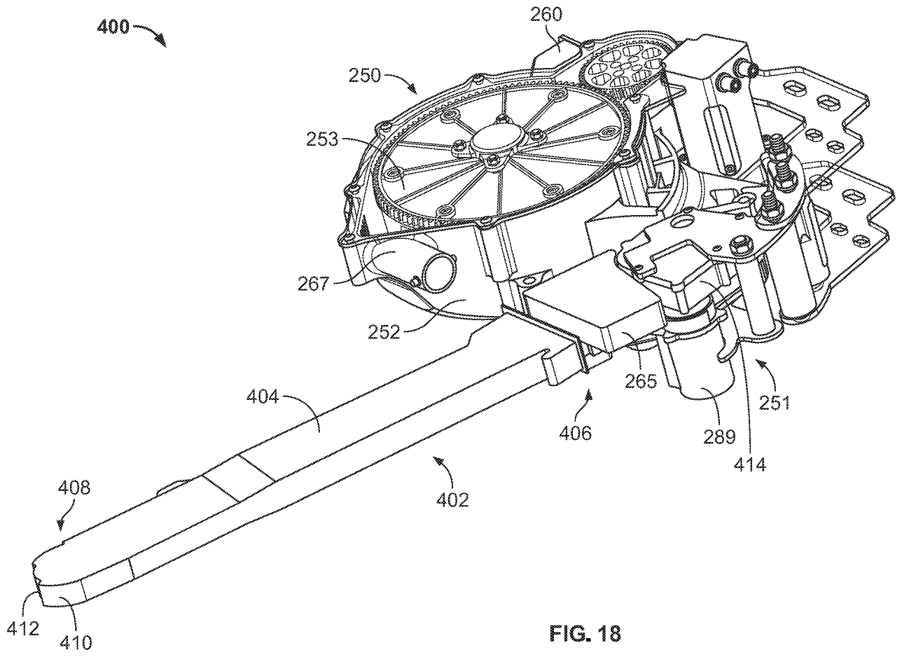

FIGS. 17-19 illustrate another example embodiment of a seed meter 400 including one or more aspects of the present disclosure. As further explained herein, the seed meter 400 of FIGS. 17-19 may be used in a desired planting unit, planter, etc. for use in planting seeds of different types and/or sizes in a field (e.g., different plots in the field).

The seed meter 400 is similar to the seed meter 220 described with reference to FIGS. 8-12 (such that the above description of the seed meter 220 (and the corresponding parts therein) generally applies to the seed meter 400). For example, the seed meter 400 of FIGS. 17-19 generally includes the seed handler portion 250 having the housing 252 and the drum 253 disposed within the housing 252, and the seed separator portion 251 having the housing 262 and the seed disc 100, 100′, 600-1300 (not visible) disposed within the housing 262. The seed meter 400 also generally functions in the same manner as the seed meter 220, in that the drum 253 and the seed disc 100, 100′, 600-1300 are configured to rotate (e.g., via the motor 289, etc.), whereby seeds (received through the inlet 260) are presented or delivered by the drum 253 to the seed disc 100, 100′, 600-1300. The multiple seed receptacles 104, 104′, 604-1304 of the seed disc 100, 100′, 600-1300 are configured to receive, capture, hold, entrain, etc. individual seeds thereon (e.g., via vacuum, etc.) as the seeds are presented, and then transport the individual seeds to the exit chute 265 where they are dislodged (or released) for planting. Seeds remaining in the drum 253 may be removed via the evacuation nozzle 267 as explained above.

In the illustrated embodiment of FIGS. 17-19, the seed meter 400 also includes a planting tube 402 in communication with the exit chute 265 of the seed meter 400 (and thus also in communication with the seed disc 100, 100′, 600-1300 in the seed meter 400). As shown, the planting tube 402 generally includes an elongated body 404 having one end 406 connected with the exit chute 265 and another opposing end 408. The elongated body 404 further includes a tip 410 (at the end 408) defining an opening 412.

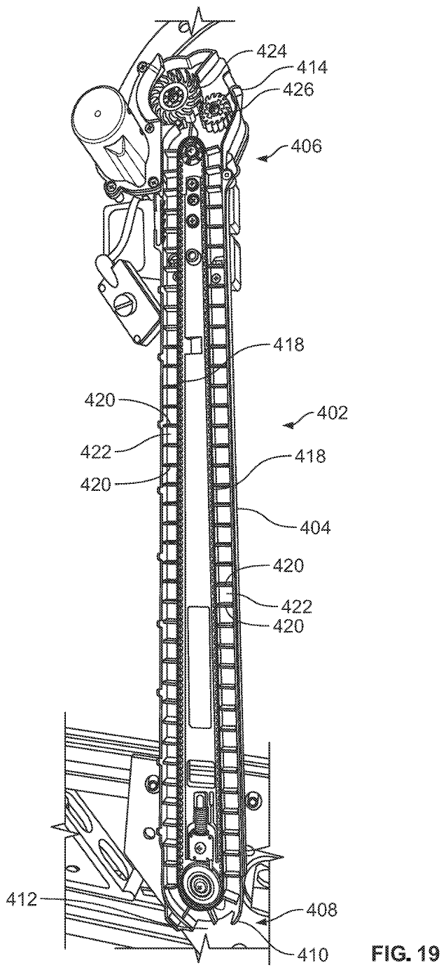

During operation, individual seeds are generally passed through the exit chute 265 (as described above with regard to the seed meter 220) and guided through the planting tube 402, and then are planted in a corresponding furrow (generally one-by-one, based on the singulation operation of the seed disc 100, 100′, 600-1300). For example, and as shown in FIG. 19, the planting tube 402 may include a conveyor belt 418 within the body 404 and extending substantially from the end 406 to the end 408 of the body 404. The conveyor belt 418 is configured to move (e.g., via a motor such as the motor 289, etc.) within the body 404. In such examples, multiple protruding members 420 are attached to the conveyor belt 418 and extend substantially to an inner surface of the body 404. This arrangement forms multiple movable partitioned areas 422 each defined by two adjacent protruding members 420, a portion of the conveyor belt 418 between the two adjacent protruding members 420, and the inner surface of the body 404. As individual seeds are passed from the exit chute, inlet gears 424, 426 (e.g., located in a housing 414, etc.) are configured to guide the individual seeds into individual partitioned areas 422 as the conveyor belt 418 moves. The individual seeds are then transported down the tube 402 (within the body 404) in the individual partitioned areas 422 towards the tip 410, as the conveyor belt 418 and protruding members 420 move. At the tip 410, the individual seeds fall (e.g., due to gravity, etc.) through the opening 412 and into the furrow one-by-one, based on the singulation operation of the seed disc 100, 100′, 600-1300 and the additional/corresponding singulation operation of the planting tube 402. In some embodiments, the tip 410 and/or other portions of the tube 402 near the end 408 may be inserted in the furrow during the planting process. In this manner, the planting tube 402, including its conveyor belt 418, protruding members 420, and inlet gears 424, 426, provides for controlled planting of seeds with uniform and consistent seed spacing (e.g., six inch spacing, etc.) in the furrow as the seeds pass through the inlet gears and the body 404 and to the ground.

In various embodiments, the seed meter 220 of FIGS. 8-12 and/or the seed meter 700 of FIGS. 16A-B may be modified (or retrofitted) as follows to achieve the seed meter 400 and/or another suitable seed meter, for incorporating the planting tube 402 (as shown in FIGS. 17-19). For example, the following steps (in no particular order) may be performed to modify the seed meter 220 to achieve the seed meter 400 (and to thereby allow the seed meter 400 to include the planting tube 402): (a) an existing planting tube of the seed meter 220 is removed; (b) the portions 250, 251 of the seed meter 220 are rotated (or skewed) by a desired amount (e.g., about 27 degrees about a generally vertical axis, etc.); (c) the evacuation nozzle 267 is moved to correspond to the rotated seed meter 220; (d) the drum 253 is shifted to a new orientation based on the rotated seed meter 220; (e) a vacuum housing is reconfigured to expose the seed disc 100, 100′, 600-1300; (f) the motor 289 (and/or other motors) are moved to avoid obstructing the new planting tube 402 (when attached); (g) the layout of the seed inlet 260 is adjusted based on the rotated seed meter 220; (h) the evacuation nozzle 267 is shifted downward to accommodate the new planting tube 402 and modified (e.g., the geometry, etc.) to correct interferences; and (i) supports are added to secure the position of the new planting tube 402. Although the above-mentioned steps are referenced in modifying the seed meter 220, it should be appreciated that one or more of the steps may be omitted during this process and/or the above-mentioned steps (with one or more of the steps may be omitted) may be applied with respect to the seed meter 700 without departing from the scope of the disclosure.

In various embodiments, the seed meters disclosed herein, such as the seed meters 220, 400, 700 having the seed disc 10, 100, 100′, 600-1300 and/or other seed discs disclosed herein, may be employed in a planter configured to plant seeds in a field. In such examples, the planter may include, for example, one or more planting units each including a seed meter with the seed disc. Various examples of planters and planting units suitable for employing the seed discs 100, 100′, 600-1300 can be again found in, for example, Applicant's co-owned U.S. Pat. No. 10,159,176 and U.S. Publication No. 2020/0329629, the entire disclosures of which are incorporated herein by reference.

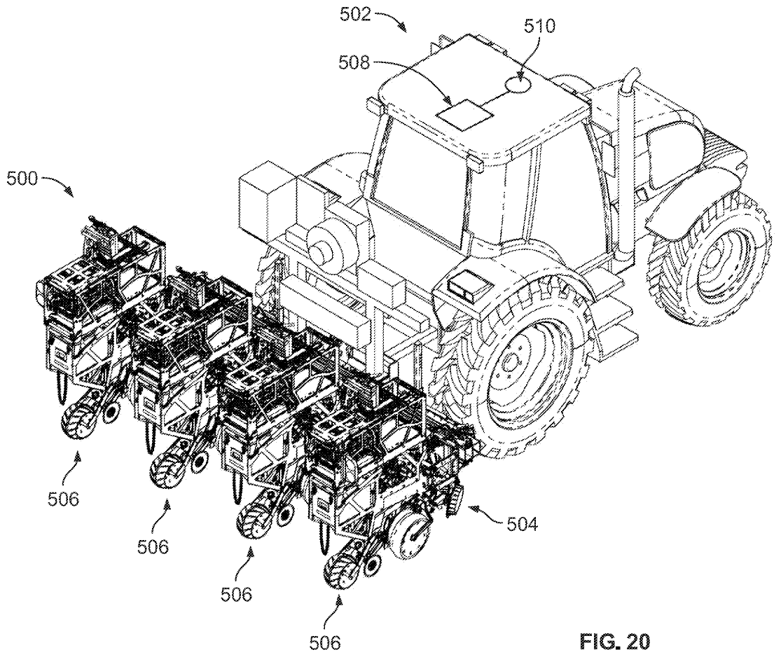

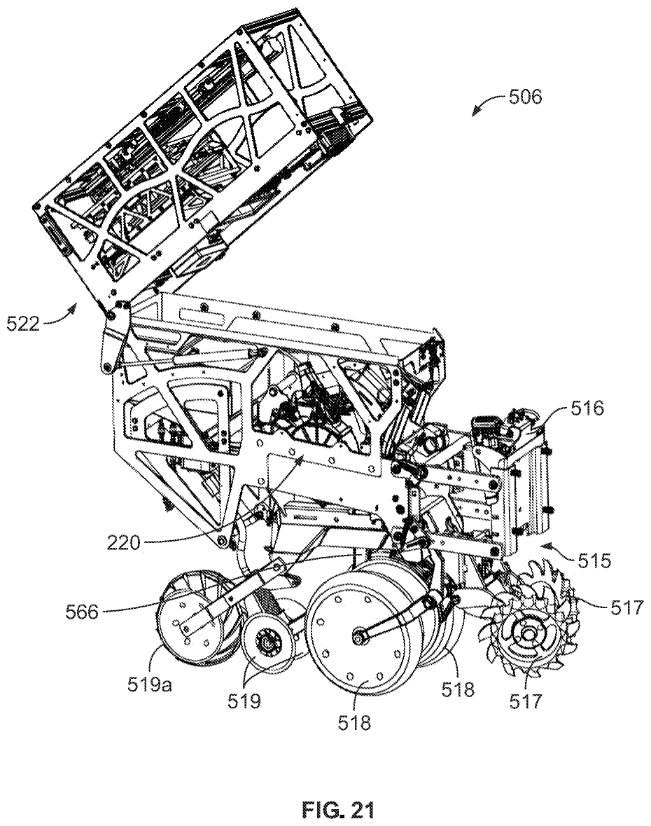

For example, FIGS. 20-21 illustrate an example embodiment of a multi-row planter 500 and a planting unit 506 including one or more aspects of the present disclosure. As further explained herein, the planter 500 is configured to plant seeds in a field or plot.

As shown in FIG. 20, in this example embodiment, when the planter 500 is in the field, it may be adapted to be towed by a conventional tractor 502 for planting the seeds. And, a control system 508 is provided in communication with the planter 500, and is configured to control one or more operations of the planter 500 and/or of the tractor 502. For example, the control system 508 may be configured to control rotation of the drum 253, rotation of the seed disc 100, 100′, 600-1300, etc. of the seed meter 220 of FIGS. 8-12 (or of the seed meter 400 of FIGS. 17-19).

As illustrated, the control system 508 is disposed in the tractor 502. However, the control system 508 may be located otherwise, for example, on the planter 500 or remote therefrom in other embodiments. In connection therewith, the control system 508 may include (and/or be associated with) a global positioning system (GPS) receiver 510, whereby the control system 508 and the GPS receiver 510 may be configured to control operation of the tractor 502 to move through the field/plot, and to control operation of the planter 500 to plant seeds in the field/plot (as generally described herein). In addition, in some embodiments, the planter 500 may be fully automated and may make use of planting plans to determine seeds to be planted (in conjunction with the control system 508 and the GPS receiver 510), and/or may make use of one or more sensors (and/or artificial intelligence from sources remote to the planter 500 but still in communication with the planter 500 via the control system 508, etc.) to identify particular field characteristics and thus particular seeds to be planted (based on the field characteristics) as modifications to the planting plans (or as a basis of the planting plans).

As shown in FIG. 20, the planter 500 generally includes a frame 504 supporting multiple planting units 506, which are adjustable relative to the frame 504. For example, the planting units 506 are configured to slide laterally along the frame 504 to thereby change spacing between the planting units 506 (e.g., to allow for compact travel, to adjust spacing between the planting units 506 during planting (e.g., on the fly without stopping, etc.) to thereby adjust spacing between rows of planted seeds, etc.). The planting units 506 may also be configured to be collapsed or folded relative to the frame 504 to a width such that the planter 500 can travel on conventional roads. With that said, in this embodiment, the planter 500 includes four planting units 506. However, in other embodiments, the planter 500 may include more than or fewer than four planting units within the scope of the present disclosure (e.g., two planting units, six planting units, eight planting units, twenty planting units, etc.). And, each of the planting units 506 is substantially identical in structure and functionality. As such, for clarity and simplicity, a single one of the planting units 506 is described hereinafter with it understood that such description equally applies to each of the other planting units 506 of the planter 500.

With reference to FIG. 21, the planting unit 506 includes a parallel linkage assembly 515, having an actuator 516 configured (e.g., structured, operable, etc.) to apply lifting and/or downward force on the planting unit 506 relative to the frame 504 (e.g., during planting, etc.) (again see, e.g., Applicant's co-owned U.S. Pat. No. 10,159,176, the entire disclosure of which is incorporated herein by reference; etc.). The planting unit 506 also includes a pair of row cleaners 517 configured to clear a path for planting, and a pair of furrow opening discs 519 configured (in conjunction with the downward force applied by the parallel linkage assembly 515) to open a V-shaped trench, or furrow, in the soil in the given field (into which seeds are then dispensed by the planting unit 506). The planting unit 506 additionally includes a pair of gauge wheels 518 configured to control a depth of the furrow formed by the opening discs 519. In particular, a height of the gauge wheels 518 relative to the opening discs 519 controls the depth of the furrow. Further, the planting unit 506 includes a closing wheel 519a configured to close the furrow, after the seeds are deposited therein, and to cover the planted seeds.

As shown in FIG. 21, the planting unit 506 also includes the seed meter 220 of FIGS. 8-12 in communication with one or more seed storage units onboard the planting unit 506 (e.g., a seed storage unit 522). In this embodiment, the seed meter 220 is disposed generally below the one or more seed storage units. As such, based on this positioning, gravity may be used to facilitate movement of the seeds from one or more storage units to the seed meter 220 (however, air, etc. may also be used as desired in other embodiments). The seed meter 220 is configured to receive seeds and dispense the received seeds into the furrow created by the planting unit 506 (i.e., created by the furrow opening discs 519) (via a planting tube 566 in communication with the seed meter 220 (see, FIG. 21)). In particular, the seed meter 220 is configured to receive seeds from the one or more storage units, meter the seeds, and then deposit (i.e., plant) a particular number (and/or volume) of the seeds into the furrow via planting tube 266 (again see, e.g., Applicant's co-owned U.S. Pat. No. 10,159,176, the entire disclosure of which is incorporated herein by reference; etc.) (or, via planting tube 402 of the seed meter 400 when the seed meter 400 is used in the planting unit 506 and/or when the seed meter 220 is modified to include the planting tube 402 as described above, etc.).

By employing the seed discs herein, with the apertures and the one or more supports within the apertures, different sized seeds may be attached against the seed discs and received, contained, held, entrained, etc. within the apertures for planting. For example, a single seed disc including apertures and one or more supports therein may be configured to entrain seeds of different sizes such as small seeds, medium seeds, and large seeds. In such examples, smaller seeds are prevented from becoming stuck in the apertures due to the one or more supports and larger seeds are able to adequately attach to the seed disc due to sufficient surface area of vacuum suction. As such, the seed discs herein enable a substantially universal solution for planting various seeds of different sizes by leveraging one or more bracings or supports within the apertures. In doing so, users are not required to manually separate out differently sized seeds and/or swap between various seed discs to plant differently sized seeds. In this manner, the seed discs herein may improve yield through increased planting reliability at fields and sites whose suppliers provide less than uniform seeds, and reduce downtime, hardware, labor, etc. otherwise required to maintain and/or modify seed meters for planting differently sized seeds as compared to the conventional industry standard.

In various examples, in using seed discs according to the present disclosure (e.g., seed discs consistent with seed disc 100, with seed disc 100′, with seed discs 600-1300, etc.) in planting trials, the discs planted upwards of about 98% of seeds (e.g., at least about 98% of all seeds to be planted in the trials were actually planted and/or were successfully delivered to the ground, etc. In fact, in many cases, the total number of seeds failed to plant for plots in the trials was reduced as compared to conventional seed discs, thereby providing an improvement over conventional seed discs.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above-mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A seed disc for a seed meter of a planter configured to plant seeds in a field, the seed disc comprising:
a plate defined by a rounded outer perimeter; and
multiple seed receptacles configured to receive and hold seeds on the plate when the seed disc rotates, the seed receptacles formed in the plate adjacent the outer perimeter, at least one seed receptacle of the multiple seed receptacles including an outer edge defining an aperture extending through the plate and one or more supports positioned within the aperture.

2. The seed disc of claim 1, wherein the one or more supports of the at least one seed receptacle include one or more arms extending radially from the outer edge of the at least one seed receptacle towards a center of the aperture of the at least one seed receptacle.

3. (canceled)

4. The seed disc of claim 2, wherein the one or more supports of the seed receptacle further include an outer support and an inner support, and wherein the one or more arms extend between the outer support and the inner support.

5. The seed disc of claim 4, wherein the plate includes a first side and a second side opposing the first side, wherein the aperture of the seed receptacle extends through the plate between the first side and the second side, and wherein the inner support is recessed within the outer edge between the first side and the second side.

6. The seed disc of claim 5, wherein the one or more arms extend between the outer edge adjacent to the second side and the inner support adjacent to the first side; and/or
wherein the inner support defines an annular shape, and wherein the aperture includes an inner aperture portion defined by the annular shape of the inner support.

7. (canceled)

8. The seed disc of claim 6, wherein the inner aperture portion defines a generally circular shape having a diameter ranging from about 0.07 inches to about 0.08 inches.

9. The seed disc of claim 4, wherein the outer support, the inner support, and the one or more arms define one or more outer aperture portions within the rounded outer edge of the seed receptacle and outside the inner support.

10. (canceled)

11. The seed disc of claim 1, wherein the one or more supports divide the aperture into multiple aperture portions.

12. (canceled)

13. The seed disc of claim 2, wherein the plate includes a first side and a second side opposing the first side, wherein the aperture of the seed receptacle extends through the plate between the first side and the second side, and wherein the one or more arms extend from the outer edge adjacent to the first side of the plate towards the second side of the plate; and/or
wherein at least a portion of the one or more arms is recessed within the outer edge between the first side and the second side.

14. (canceled)

15. The seed disc of claim 2, wherein the aperture includes an annular aperture portion, and wherein the one or more arms at least partially define the annular aperture portion of the aperture; or
wherein the aperture includes one or more trapezoidal shape aperture portions, and wherein the one or more arms at least partially define the trapezoidal shape aperture portions of the aperture.

16.-19. (canceled)

20. The seed disc of claim 1, wherein the seed receptacle is configured to entrain seeds of different sizes.

21. A seed meter for a planter configured to plant seeds in a field, the seed meter comprising:
the seed disc of claim 1; and
a rotatable drum operatively coupled to the seed disc, the drum including at least one seed pocket configured to hold seeds, the at least one seed pocket including an opening configured to present the seeds to the seed disc;
wherein the seed disc is configured to rotate relative to the drum, and wherein the multiple receptacles of the seed disc are configured to receive and hold individual ones of the seeds on the plate of the seed disc as the seeds are presented to the seed disc when the seed disc rotates relative to the drum.

22. The seed meter of claim 21, wherein the multiple receptacles of the seed disc are configured to hold the individual ones of the seeds on the plate via a vacuum applied to the receptacles.

23. The seed meter of claim 21, further comprising a planting tube in communication with the seed disc, wherein the seed disc is configured to transport the individual seeds from the at least one seed pocket and release the individual seeds into the planting tube as the seed disc rotates, and wherein the planting tube is configured to guide the individual seeds to the ground for planting.

24. The seed meter of claim 21, further comprising an ejector operatively coupled to the seed disc, the ejector including at least one spur having a shape corresponding to a shape of the at least one seed receptacle of the multiple receptacles, the at least one spur configured to extend into the at least one seed receptacle and dislodge seeds and/or debris from the at least one seed receptacle.

25. The seed meter of claim 24, wherein the ejector is configured to rotate in a plane that is perpendicular to the seed disc.

26. The seed meter of claim 24, wherein the at least one spur includes an inner protrusion and three outer protrusions spaced about the inner protrusion.

27. The seed meter of claim 26, wherein the three outer protrusions are equally spaced about the inner protrusion; and/or
wherein each of the outer protrusions has an arcuate cross-sectional shape and the inner protrusion has a circular cross-sectional shape.

28. (canceled)

29. The seed meter of claim 24, wherein the ejector includes two or more spurs.

30. A planter for planting seeds in a field, the planter comprising at least one planting unit including the seed meter of claim 21.

31. A seed meter for a planter configured to plant seeds in a field, the seed meter comprising:
a seed disc including a plate defined by an outer perimeter and multiple seed receptacles configured to receive and hold seeds on the plate when the seed disc rotates, at least one seed receptacle of the multiple seed receptacles defining an aperture extending through the plate and including one or more supports positioned within the aperture; and
a rotatable drum operatively coupled with the seed disc, the drum including at least one seed pocket configured to hold seeds, the at least one seed pocket including an opening configured to present the seeds to the seed disc;
wherein the seed disc is configured to rotate relative to the drum, and wherein the multiple receptacles of the seed disc are configured to receive and hold individual ones of the seeds on the plate of the seed disc as the seeds are presented to the seed disc when the seed disc rotates relative to the drum.

32. The seed meter of claim 31, further comprising an ejector operatively coupled to the seed disc, the ejector including at least one spur having a shape corresponding to a shape of the at least one seed receptacle of the multiple receptacles, the at least one spur configured to extend into the at least one seed receptacle and dislodge seeds and/or debris from the at least one seed receptacle.

33. The seed meter of claim 32, wherein the ejector is configured to rotate in a plane that is perpendicular to the seed disc.

34. A planter for planting seeds in a field, the planter comprising:
at least one planting unit including a seed meter configured to plant seeds in a field, the seed meter including:
a seed disc including a plate defined by an outer perimeter and multiple seed receptacles configured to receive and hold seeds on the plate when the seed disc rotates, at least one seed receptacle of the multiple seed receptacles defining an aperture extending through the plate and including one or more supports positioned within the aperture; and
a rotatable drum operatively coupled with the seed disc, the drum including at least one seed pocket configured to hold seeds, the at least one seed pocket including an opening configured to present the seeds to the seed disc;
wherein the seed disc is configured to rotate relative to the drum, and wherein the multiple receptacles of the seed disc are configured to receive and hold individual ones of the seeds on the plate of the seed disc as the seeds are presented to the seed disc when the seed disc rotates relative to the drum.
